(19) United States
(12) Patent Application Publication
(10) Pub. No.: US 2019/0185791 A1
(43) Pub. Date: Jun. 20, 2019

(54) USE OF ENZYMES, CLEANING COMPOSITION AND METHOD FOR WASHING

(71) Applicant: NOVOZYMES A/S, Bagsvaerd (DK)

(72) Inventor: Leigh Murphy, Roskilde (DK)

(73) Assignee: NOVOZYMES A/S, Bagsvaerd (DK)

(21) Appl. No.: 16/304,374

(22) PCT Filed: May 24, 2017
(86) PCT No.: PCT/EP2017/062501

§ 371 Date: Nov. 26, 2018

(30) Foreign Application Priority Data
May 26, 2016 (EP) 16171521.4

(51) Int. Cl. C11D 3/386; C11D 11/00

(52) U.S. Cl. CPC C11D 3/38645; C11D 11/0023; C11D 3/38636; C11D 3/38654

(57) ABSTRACT

The present invention concerns the use of enzymes for preventing, reducing or removing odor, a cleaning composition comprising enzymes and a method for washing an hard surface.

### FIELD OF THE INVENTION

The present invention concerns the use of enzymes for preventing, reducing or removing odor, a cleaning composition comprising enzymes and a method for washing an item.

### REFERENCE TO A SEQUENCE LISTING

This application contains a Sequence Listing in computer readable form. The computer readable form is incorporated herein by reference.

### BACKGROUND OF THE INVENTION

Use of enzymes in dishwashing detergents is well known in the field of both automatic dishwashing (ADW) formulas, and in hand dishwashing formulas. Typically proteases and amylases are used in commercial dishwashing detergents. These enzymes are useful for degrading protein and starch/amylose, respectively. However, other kinds of food material than protein and amylose left on dishes may is not degraded by protease and amylase and will remain in the filter of the dishwashing machine. This can give rise to development of undesirable odorous compounds.

### SUMMARY OF THE INVENTION

The present invention concerns the use of at least one enzyme for preventing, reducing or removing odor from an item, wherein the at least one enzyme is selected from an alkaline cellulase and/or an enzyme having mannanase activity.

The invention further concerns a cleaning composition comprising a builder and at least one enzyme for preventing, reducing or removing odor from an item, wherein the at least one enzyme is selected from an alkaline cellulase and/or an enzyme having mannanase activity.

Further is invented a method for washing an item, wherein the method comprises the steps of:
(i) Exposing the item to a wash liquor comprising at least one enzyme selected from an alkaline cellulase and/or an enzyme having mannanase activity or the dishwashing composition according to the invention; and
(ii) Rinsing the item with water optionally comprising a rinsing aid;
   wherein the item is a dishware or a hard surface.

### Definitions

Carbohydrate oxidase: EC 1.1.3.10 systematic name: pyranose:oxygen 2-oxidoreductase, A flavoprotein (FAD). Also oxidizes D-xylose, L-sorbose and D-glucono-1,5-lactone, which have the same ring conformation and configuration at C-2, C-3 and C-4.

Cellobiose oxidase: EC 1.1.3.25, EC 1.1.99.18 Generally this can be stated as: cellobiose+acceptor F⇄cellobiono-1,5-lactone+reduced acceptor, if dioxygen is the acceptor the product is hydrogen peroxide.

Detergent components: The term “detergent components” is defined herein to mean the types of chemicals which can be used in detergent compositions for automatic dishwashing. Examples of detergent components are polymers, bleaching systems, bleach activators, bleach catalysts, silicates, dyestuff and metal care agents.

Dishware: The term dish ware is intended to mean any form of kitchen utensil, dinner set or tableware such as but not limited to pans, plates, cops, knives, forks, spoons, porcelain etc.

Dish wash: The term “dish wash” refers to all forms of washing dishes, e.g. by hand (MDW) or automatic dish wash (ADW). Washing dishes includes, but is not limited to, the cleaning of all forms of crockery such as plates, cups, glasses, bowls, all forms of cutlery such as spoons, knives, forks and serving utensils as well as ceramics, plastics, metals, china, glass and acrylics.

Dish washing composition: The term “dish washing composition” refers to compositions intended for cleaning dishware such as plates, cups, glasses, bowls, cutlery such as spoons, knives, forks, serving utensils, ceramics, plastics, metals, china, glass and acrylics in a dishwashing machine. The terms encompass any materials/compounds selected for household or industrial washing applications and the form of the product can be liquid, powder or granulate. In addition enzymes, the automatic dishwashing composition contains detergent components such as polymers, bleaching systems, bleach activators, bleach catalysts, silicates, dyestuff and metal care agents. The dishwashing composition can be use in manual dishwashing (MDW) or automatic dishwashing (ADW).

Endoglucanase: The term “endoglucanase” means an endo-1,4-(1,3;1,4)-beta-D-glucan 4-glucanohydrolase (E.C. 3.2.1.4) that catalyzes endohydrolysis of 1,4-beta-D-glycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or xyloglucans, and other plant material containing cellulosic components. Endoglucanase activity can be determined by measuring reduction in substrate viscosity or increase in reducing ends determined by a reducing sugar assay (Zhang et al., 2006, Biotechnology Advances 24: 452-481). For purposes of the present invention, endoglucanase activity is determined using carboxymethyl cellulose (CMC) as substrate according to the procedure of Ghose, 1987, Pure and Appl. Chem. 59: 257-268, at pH 5, 40° C.

Glucose oxidase: The glucose oxidase enzyme (GOx) also known as notatin (EC number 1.1.3.4) is an oxido-reductase that catalyses the oxidation of glucose to hydrogen peroxide and D-glucono-δ-lactone.

Hard surface cleaning: The term “Hard surface cleaning” is defined herein as cleaning of hard surfaces wherein hard surfaces may include floors, tables, walls, roofs etc. as well as surfaces of hard objects such as cars (car wash) and dishes (dish wash). Dish washing includes but are not limited to cleaning of plates, cups, glasses, bowls, cutlery such as spoons, knives, forks, serving utensils, ceramics, plastics, metals, china, glass and acrylics.

Sequence identity: The relatedness between two amino acid sequences or between two nucleotide sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the—nobrief option) is used as the percent identity and is calculated as follows:

(Identical Deoxyribonucleotides×100)/(Length of Alignment−Total Number of Gaps in Alignment)

Variant: The term “variant” means a polypeptide having enzyme activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Wash cycle: The term “wash cycle” is defined herein as a washing operation wherein dishware are exposed to the wash liquor for a period of time by circulating the wash liquor and spraying the wash liquor onto the dishware in order to clean the dishware and finally the superfluous wash liquor is removed. A wash cycle may be repeated one, two, three, four, five or even six times at the same or at different temperatures. Hereafter the dishware is generally rinsed and dried. One of the wash cycles can be a soaking step, where the dishware is left soaking in the wash liquor for a period.

Wash liquor: The term “wash liquor” is intended to mean the solution or mixture of water and detergents optionally including enzymes used for dishwashing.

Overview of Sequences Listing

SEQ ID NO: 1 is the amino acid sequence of a cellulase. SEQ ID NO: 2 is the amino acid sequence of a mannanase.
SEQ ID NO: 3 is the amino acid sequence of a glucose oxidase.
SEQ ID NO: 4 is the amino acid sequence of a cellobiose oxidase.
SEQ ID NO: 5 is the amino acid sequence of an amylase.
SEQ ID NO: 6 is the amino acid sequence of a protease.
SEQ ID NO: 7 is the amino acid sequence of a protease.

### DETAILED DESCRIPTION OF THE INVENTION

The invention concerns the use of at least one enzyme for preventing, reducing or removing odor from an item, wherein the at least one enzyme is selected from an alkaline cellulase and/or an enzyme having mannanase activity.

The invention further concerns a dishwashing composition comprising a builder and at least one enzyme for preventing, reducing or removing odor from an item, wherein the at least one enzyme is selected from an alkaline cellulase and/or an enzyme having mannanase activity.

In accordance with the invention the enzymes or the dishwashing composition can be used in a method for washing an item, wherein the method comprises the steps of:
a) Exposing the item to a wash liquor comprising at least one enzyme selected from an alkaline cellulase and/or an enzyme having mannanase activity or the dishwashing composition according to the invention; and
b) Rinsing the dishes with water optionally comprising a rinsing aid;
   wherein the item is a dishware or a hard surface.

In one embodiment of the invention the method is hand dishwashing or automatic dish washing. In one embodiment the method is for washing or cleaning of dishware.

The item can be a dish ware or a hard surface. In one embodiment of the invention the item is the interior of a dishwashing machine or a sink, such as walls, baskets, nozzles, pumps, sump, filters, pipelines, drains, and outlets.

The at least one enzyme for preventing, reducing or removing odor from an item can be an alkaline cellulase, which alkaline cellulase is an enzyme exhibiting endo-beta-1,4-glucanase activity (EC 3.2.1.4). One example of an enzyme exhibiting endo-beta-1,4-glucanase activity is the enzyme of SEQ ID NO: 1, or an enzyme variant having at least 80% sequence identity to SEQ ID NO: 1. In one embodiment the enzyme variant has at least 85% sequence identity to SEQ ID NO: 1, at least 90% sequence identity to SEQ ID NO: 1, at least 95% sequence identity to SEQ ID NO: 1, at least 96% sequence identity to SEQ ID NO: 1, at least 97% sequence identity to SEQ ID NO: 1, at least 98% sequence identity to SEQ ID NO: 1 or at least 99% sequence identity to SEQ ID NO: 1.

The at least one enzyme for preventing, reducing or removing odor from an item can be a mannanase enzyme having at least 80% sequence identity to SEQ ID NO: 2. One example of an enzyme exhibiting mannanase activity is the enzyme of SEQ ID NO: 2, or an enzyme variant having at least 80% sequence identity to SEQ ID NO: 2. In one embodiment the enzyme variant has at least 85% sequence identity to SEQ ID NO: 2, at least 90% sequence identity to SEQ ID NO: 2, at least 95% sequence identity to SEQ ID NO: 2, at least 96% sequence identity to SEQ ID NO: 2, at least 97% sequence identity to SEQ ID NO: 2, at least 98% sequence identity to SEQ ID NO: 2 or at least 99% sequence identity to SEQ ID NO: 2.

Experiments have shown that use an alkaline cellulase and/or an enzyme having mannanase activity together with an oxidase shows even better results for preventing, reducing or removing odor from an item. In one embodiment of the invention the at least one enzyme is used together with an oxidase.

In one embodiment of the invention the oxidase is a carbohydrate oxidase (EC 1.1.3). The carbohydrate oxidase can be a glucose oxidase (EC 1.1.3.4), a dehydrogenase, a cellobiose oxidase (EC 1.1.99.18).

In one embodiment of the invention the glucose oxidase has at least 80% sequence identity to SEQ ID NO: 3. One example of an enzyme exhibiting glucose oxidase activity is the enzyme of SEQ ID NO: 3, or an enzyme variant having at least 80% sequence identity to SEQ ID NO: 3. In one embodiment the enzyme variant has at least 85% sequence identity to SEQ ID NO: 3, at least 90% sequence identity to SEQ ID NO: 3, at least 95% sequence identity to SEQ ID NO: 3, at least 96% sequence identity to SEQ ID NO: 3, at least 97% sequence identity to SEQ ID NO: 3, at least 98% sequence identity to SEQ ID NO: 3 or at least 99% sequence identity to SEQ ID NO: 3.

In one embodiment of the invention the cellobiose oxidase has at least 80% sequence identity to SEQ ID NO: 4. One example of an enzyme exhibiting cellobiose oxidase activity is the enzyme of SEQ ID NO: 4, or an enzyme variant having at least 80% sequence identity to SEQ ID NO: 4. In one embodiment the enzyme variant has at least 85% sequence identity to SEQ ID NO: 4, at least 90% sequence identity to SEQ ID NO: 4, at least 95% sequence identity to SEQ ID NO: 4, at least 96% sequence identity to SEQ ID NO: 4, at least 97% sequence identity to SEQ ID NO: 4, at least 98% sequence identity to SEQ ID NO: 4 or at least 99% sequence identity to SEQ ID NO: 4.

The alkaline cellulase and/or an enzyme having mannanase activity optionally together with an oxidase is very effectively in preventing, reducing or removing the odor for items. In one embodiment of the invention the odor is reduced by at least 50% when measured with Assay I. In one embodiment the odor is reduced by at least 60%, at least 70%, at least 80%, at least 90%, at least 95%, at least 96%, at least 97%, at least 98% or at least 99% when measured with Assay I.

The reduction in volatile compounds can also be measured by the human nose, e.g. by scoring the presence of odorous compounds according to Assay II. In one embodiment of the invention the presence of odor is scored on average 3 points lower than control (without use of the inventive enzymes) when measured with Assay II. In one embodiment the presence of odor is scored on average 4 points, 5 points, 6 points, 7 points or 8 points lower than control when measured with Assay II.

The alkaline cellulase and/or an enzyme having mannanase activity optionally together with an oxidase can be used together with other enzymes. The enzymes may be used together with one or more enzymes such as a protease, lipase, cutinase, an amylase, carbohydrase, cellulase, pectinase, mannanase, arabinase, galactanase, xylanase, DNase, oxidase, e.g., a laccase, and/or peroxidase.

In one embodiment of the invention the alkaline cellulase and/or an enzyme having mannanase activity optionally together with an oxidase may be used with an amylase and/or a protease.

In one embodiment of the invention the amylase is an alpha-amylase or a glucoamylase. The amylase may be of bacterial or fungal origin. In one embodiment the amylase is an alpha-amylase obtained from Bacillus, such as Bacillus licheniformis.

In one embodiment of the invention the protease is chemically modified or protein engineered. The protease can be a serine protease or a metalloprotease, preferably an alkaline microbial protease or a trypsin-like protease. In one embodiment the protease is selected from the group consisting of Bacillus, e.g., subtilisin Novo, subtilisin Carlsberg, subtilisin 309, subtilisin 147, subtilisin 168, trypsin of bovine origin, trypsin of porcine origin and Fusarium protease.

When the alkaline cellulase and/or an enzyme having mannanase activity is present in a dishwashing composition the composition may further comprise a builder. The composition may further comprise a surfactant. In one embodiment of the invention the composition further comprises one or more builders and one or more polymer.

The composition may further comprise one or more components selected from the group consisting of polymers, bleaching systems, bleach activators, bleach catalysts, silicates, dyestuff and metal care agents. The components are further described in the below paragraphs.

The composition can be in the form of a powder, a bar, a homogenous tablet, a tablet having two or more layers, a pouch having one or more compartments, a regular or compact powder, a granule, a paste, a gel, or a regular, compact or concentrated liquid.

### Surfactants

The dish washing composition can include at least one non-ionic surfactant. Suitable nonionic surfactants include, but are not limited to low-foaming nonionic (LFNI) surfactants. A LFNI surfactant is most typically used in an automatic dishwashing composition because of the improved water-sheeting action (especially from glassware) which they confer to the automatic dishwashing composition. They also may encompass non-silicone, phosphate or nonphosphate polymeric materials which are known to defoam food soils encountered in automatic dishwashing. The LFNI surfactant may have a relatively low cloud point and a high hydrophilic-lipophilic balance (HLB). Cloud points of 1% solutions in water are typically below about 32° C. and alternatively lower, e.g., 0° C., for optimum control of sudsing throughout a full range of water temperatures. If desired, a biodegradable LFNI surfactant having the above properties may be used.

A LFNI surfactant may include, but is not limited to: alkoxylated surfactants, especially ethoxylates derived from primary alcohols, and blends thereof with more sophisticated surfactants, such as the polyoxypropylene/polyoxyethylene/polyoxypropylene reverse block polymers. Suitable block polyoxyethylene-polyoxypropylene polymeric compounds that meet the requirements may include those based on ethylene glycol, propylene glycol, glycerol, trimethylolpropane and ethylenediamine, and mixtures thereof. Polymeric compounds made from a sequential ethoxylation and propoxylation of initiator compounds with a single reactive hydrogen atom, such as C 12—is aliphatic alcohols, do not generally provide satisfactory suds control in Automatic dishwashing compositions. However, certain of the block polymer surfactant compounds designated as PLURONIC® and TETRONIC® by the BASF-Wyandotte Corp., Wyandotte, Mich., are suitable in Automatic dishwashing compositions. The LFNI surfactant can optionally include a propylene oxide in an amount up to about 15% by weight. Other LFNI surfactants can be prepared by the processes described in U.S. Pat. No. 4,223,163. The LFNI surfactant may also be derived from a straight chain fatty alcohol containing from about 16 to about 20 carbon atoms (C16-C20 alcohol), alternatively a Cl8 alcohol, condensed with an average of from about 6 to about 15 moles, or from about 7 to about 12 moles, and alternatively, from about 7 to about 9 moles of ethylene oxide per mole of alcohol. The ethoxylated nonionic surfactant so derived may have a narrow ethoxylate distribution relative to the average.

In certain embodiments, a LFNI surfactant having a cloud point below 30° C. may be present in an amount from about 0.01% to about 60%, or from about 0.5% to about 10% by weight, and alternatively, from about 1% to about 5% by weight of the composition

In preferred embodiments, the surfactant is a non-ionic surfactant or a non-ionic surfactant system having a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and stability in product than single non-ionic surfactants. Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R₁O[CH₂CH(CH₃)O]ₓ[CH₂CH₂O]_{y}[CH₂CH(OH)R₂] (I)

wherein R₁ is a linear or branched, aliphatic hydrocarbon radical having from 4 to 18 carbon atoms; R₂ is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20. Preferably, the surfactant of formula I has at least about 10 carbon atoms in the terminal epoxide unit [CH₂CH(OH)R₂]. Suitable surfactants of formula I are Olin Corporation's POLY-TERGENT® SLF-18B nonionic surfactants, as described, for example, in WO 94/22800, published Oct. 13, 1994 by Olin Corporation.

Preferably non-ionic surfactants and/or system herein have a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.). Amine oxides surfactants are also useful in the present invention as anti-redeposition surfactants include linear and branched compounds having the formula:

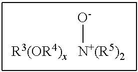

wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferable 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C₁₀-C₁₈ acylamido alkyl dimethylamine oxide. Surfactants and especially non-ionic surfactants may be present in amounts from 0 to 10% by weight, preferably from 0.1% to 10%, and most preferably from 0.25% to 6%.

### Sulfonated Polymer

The polymer, if used, is used in any suitable amount from about 0.1% to about 20%, preferably from 1% to about 15%, more preferably from 2% to 10% by weight of the composition. Sulfonated/carboxylated polymers are particularly suitable for the compositions contained in the pouch of the invention.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

As noted herein, the sulfonated/carboxylated polymers may comprise (a) at least one structural unit derived from at least one carboxylic acid monomer having the general formula (I):

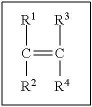

wherein R¹ to R⁴ are independently hydrogen, methyl, carboxylic acid group or CH₂COOH and wherein the carboxylic acid groups can be neutralized; (b) optionally, one or more structural units derived from at least one nonionic monomer having the general formula (II):

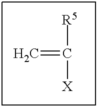

wherein R⁵ i is hydrogen, C₁ to C₆ alkyl, or C₁ to C₆ hydroxyalkyl, and X is either aromatic (with R⁵ being hydrogen or methyl when X is aromatic) or X is of the general formula (III):

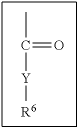

wherein R⁶ is (independently of R⁵) hydrogen, C₁ to C₆ alkyl, or C₁ to C₆ hydroxyalkyl, and Y is O or N; and at least one structural unit derived from at least one sulfonic acid monomer having the general formula (IV):

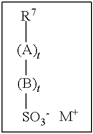

wherein R⁷ is a group comprising at least one sp² bond, A is O, N, P, S or an amido or ester linkage, B is a mono- or polycyclic aromatic group or an aliphatic group, each t is independently 0 or 1, and M⁺ is a cation. In one aspect, R⁷ is a C₂ to C₆ alkene. In another aspect, R⁷ is ethene, butene or propene.

Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or [alpha]-methyl styrene.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer. 99 The carboxylic acid is preferably (meth)acrylic acid. The sulfonic acid monomer is preferably one of the following: 2-acrylamido methyl-1-propanesulfonic acid, 2-methacrylamido-2-methyl-1-propanesulfonic acid, 3-methacrylamido-2-hydroxypropanesulfonic acid, allysulfonic acid, methallysulfonic acid, allyloxybenzenesulfonic acid, methallyloxybenzensulfonic acid, 2-hydroxy-3-(2-propenyloxy)propanesulfonic acid, 2-methyl-2-propene-I-sulfonic acid, styrene sulfonic acid, vinylsulfonic acid, 3-sulfopropyl acrylate, 3-sulfopropyl methacrylate, sulfomethylacrylamid, sulfomethylmethacrylamide, and water soluble salts thereof. The unsaturated sulfonic acid monomer is most preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 50% of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca and Mg. Any builder and/or co-builder known in the art for use in ADW detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain 0-50% by weight, such as about 5% to about 30%, of a detergent co-builder. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)ethylenediamine-N,N,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

The dish wash composition contains 0-50% by weight, such as about 5% to about 30%, of a detergent co-builder and/or the dish wash compositions is preferably phosphate free. According to one aspect of the invention the builder is selected from citric acid, methyl glycine-N,N-diacetic acid (MGDA) and/or glutamic-N,N-diacetic acid (GLDA) and mixtures thereof. According to one aspect of the invention the bleach component is selected from bleaching catalysts, photobleaches, bleach activators, sources of hydrogen peroxide such as sodium percarbonate, sodium perborates and hydrogen peroxide, preformed peracids and mixtures thereof. According to one aspect the bleach component is a peroxide such as percarbonate, persulfate, perphosphate, persilicate salts. In one aspect the bleaching component includes a percarbonate and bleach catalyst, preferably a manganese compound according to one aspect the bleach catalyst is 1,4,7-trimethyl-1,4,7-triazacyclononane or manganese (II) acetate tetrahydrate (MnTACN). In one aspect the dish wash composition comprising from 1-40 wt %, preferably from 0.5-30 wt %, of bleaching components, wherein the bleach components are a peroxide, preferably percabonate and a catalyst preferably a metal-containing bleach catalyst such as 1,4,7-trimethyl-1,4,7-triazacyclononane or manganese (II) acetate tetrahydrate (MnTACN).

### Bleaching Systems

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB-1,466,799. The weight ratio of the mixed salt coating material to percarbonate lies in the range from 1:200 to 1:4, more preferably from 1:99 to 19, and most preferably from 1:49 to 1:19. Preferably, the mixed salt is of sodium sulphate and sodium carbonate which has the general formula Na2SO4.n.Na2CO3 wherein n is from 0.1 to 3, preferably n is from 0.3 to 1.0 and most preferably n is from 0.2 to 0.5.

Another suitable coating material providing in product stability, comprises sodium silicate of SiO₂:Na2O ratio from 1.8:1 to 3.0:1, preferably L8:1 to 2.4:1, and/or sodium metasilicate, preferably applied at a level of from 2% to 10%, (normally from 3% to 5%) of SiO₂ by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein. Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein. The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process. Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-[alpha]-naphthoic acid and magnesium monoperphthalate, (b) the aliphatic or substituted aliphatic peroxy acids, such as peroxylauric acid, peroxystearic acid, [epsilon]-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60[deg.] C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the composition.

### Bleach Catalysts and Bleach Boosters

The bleaching system may also include a bleach catalyst or booster.

Bleach catalysts preferred for use herein include the manganese triazacyclononane, MnTACN and related complexes (U.S. Pat. Nos. 4,246,612, 5,227,084); Co, Cu, Mn and Fe bispyridylamine and related complexes (U.S. Pat. No. 5,114,611); and pentamine acetate cobalt(III) and related complexes(U.S. Pat. No. 4,810,410). A complete description of bleach catalysts suitable for use herein can be found in WO 99/06521, pages 34, line 26 to page 40, line 16. Bleach catalyst if included in the compositions of the invention are in a level of from about 0.1 to about 10%, preferably from about 0.5 to about 2% by weight of the composition. Oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases), can also be used according to the present invention to intensify the bleaching effect. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the stains, to ensure electron flow (mediators).

Some non-limiting examples of bleach catalysts that may be used in the compositions of the present invention include manganese oxalate, manganese acetate, manganese-collagen, cobalt-amine catalysts and manganese triazacyclononane (MnTACN) catalysts; particularly preferred are complexes of manganese with 1,4,7-trimethyl-1,4,7-triazacyclononane (Me3-TACN) or 1,2,4,7-tetramethyl-1,4,7-triazacyclononane (Me4-TACN), in particular Me3-TACN, such as the dinuclear manganese complex [(Me3-TACN)Mn(O)3Mn(Me3-TACN)](PF6)2, and [2,2′,2″-nitrilotris(ethane-1,2-diylazanylylidene-κN-methanylylidene)triphenolato-κ3O]manganese(111). The bleach catalysts may also be other metal compounds, such as iron or cobalt complexes.

In some embodiments, where a source of a peracid is included, an organic bleach catalyst or bleach booster may be used having one of the following formulae:

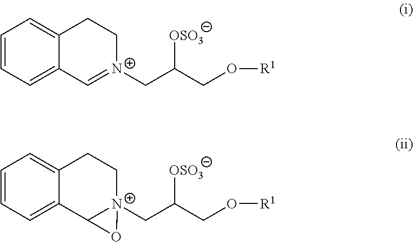

(iii) and mixtures thereof; wherein each R1 is independently a branched alkyl group containing from 9 to 24 carbons or linear alkyl group containing from 11 to 24 carbons, preferably each R1 is independently a branched alkyl group containing from 9 to 18 carbons or linear alkyl group containing from 11 to 18 carbons, more preferably each R1 is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl.
Other exemplary bleaching systems are described, e.g. in WO2007/087258, WO2007/087244, WO2007/087259, EP1867708 (Vitamin K) and WO2007/087242. Suitable photobleaches may for example be sulfonated zinc or aluminium phthalocyanines.
Other exemplary bleaching systems are described, e.g. in WO2007/087258, WO2007/087244, WO2007/087259, EP1867708 (Vitamin K) and WO2007/087242. Suitable photobleaches may for example be sulfonated zinc or aluminium phthalocyanines.

### Silicates

Preferred silicates are sodium silicates such as sodium disilicate, sodium metasilicate and crystalline phyllosilicates. Silicates if present are at a level of from about 1 to about 20%, preferably from about 5 to about 15% by weight of composition.

### Metal Care Agents

Metal care agents may prevent or reduce the tarnishing, corrosion or oxidation of metals, including aluminium, stainless steel and non-ferrous metals, such as silver and copper. Suitable examples include one or more of the following:

(a) benzatriazoles, including benzotriazole or bis-benzotriazole and substituted derivatives thereof. Benzotriazole derivatives are those compounds in which the available substitution sites on the aromatic ring are partially or completely substituted. Suitable substituents include linear or branch-chain Ci-C20-alkyl groups and hydroxyl, thio, phenyl or halogen such as fluorine, chlorine, bromine and iodine.

(b) metal salts and complexes chosen from the group consisting of zinc, manganese, titanium, zirconium, hafnium, vanadium, cobalt, gallium and cerium salts and/or complexes, the metals being in one of the oxidation states II, III, IV, V or VI. In one aspect, suitable metal salts and/or metal complexes may be chosen from the group consisting of Mn(II) sulphate, Mn(II) citrate, Mn(II) stearate, Mn(II) acetylacetonate, K̂TiF6, K̂ZrF6, CoSO4, Co(NOs)2 and Ce(NOs)3, zinc salts, for example zinc sulphate, hydrozincite or zinc acetate; (c) silicates, including sodium or potassium silicate, sodium disilicate, sodium metasilicate, crystalline phyllosilicate and mixtures thereof.

Further suitable organic and inorganic redox-active substances that act as silver/copper corrosion inhibitors are disclosed in WO 94/26860 and WO 94/26859. Preferably the composition of the invention comprises from 0.1 to 5% by weight of the composition of a metal care agent, preferably the metal care agent is a zinc salt.

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Adjunct Materials

Any detergent components known in the art for use in ADW detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use ADW detergents may be utilized. The choice of such ingredients is well within the skill of the artisan.

### Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Fluorescent Whitening Agent

The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2,2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

### Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

### Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

The invention is further summarized in the following paragraphs:
1. Use of at least one enzyme for preventing, reducing or removing odor from hard surface, wherein the at least one enzyme is selected from an alkaline cellulase and/or an enzyme having mannanase activity.
2. Use according to paragraph 1, wherein the alkaline cellulase is an enzyme exhibiting endo-beta-1,4-glucanase activity (EC 3.2.1.4)
3. Use according to paragraph 2, wherein the enzyme exhibiting endo-beta-1,4-glucanase activity has at least 80% sequence identity to SEQ ID NO: 1.
4. Use according to any of the preceding paragraphs, wherein the enzyme having mannanase activity has at least 80% sequence identity to SEQ ID NO: 2.
5. Use according to any of the preceding paragraphs, wherein the at least one enzyme is used together with an oxidase.
6. Use according to paragraph 5, wherein the oxidase is a carbohydrate oxidase (EC 1.1.3).
7. Use according to any of paragraphs 5-6, wherein the carbohydrate oxidase is a glucose oxidase (EC 1.1.3.4), a dehydrogenase a cellobiose oxidase (EC 1.1.99.18).
8. Use according to paragraph 7, wherein the glucose oxidase has at least 80% sequence identity to SEQ ID NO 3.
9. Use according to paragraph 7, wherein the cellobiose oxidase has at least 80% sequence identity to SEQ ID NO: 4.
10. Use according to any of the preceding paragraphs, wherein the odor is reduced by at least 50% when measured with Assay I and/or wherein the odor is scored on average 3 points lower than control when measured with Assay II.
11. Use according to paragraph 10, wherein the odor is reduced by at least 60%, at least 70%, at least 80%, at least 90%, at least 95%, at least 96%, at least 97%, at least 98% or at least 99% when measured with Assay I.
12. Use according to paragraph 10, wherein the odor is scored on average 4 points, 5 points, 6 points, 7 points or 8 points lower than control when measured with Assay II.
13. Use according to any of the preceding paragraphs, wherein the hard surface is a dish ware or a hard surface.
14. Use according to paragraph 13, wherein the hard surface is present in the interior of a dishwashing machine or a sink, such as walls, baskets, nozzles, pumps, sump, filters, pipelines, drains, and outlets.
15. Use according to any of paragraphs 1-14, wherein the enzymes are used in process for automatic dish wash or a process for manual dish wash.
16. A cleaning composition comprising a builder and at least one enzyme for preventing, reducing or removing odor from a hard surface, wherein the at least one enzyme is selected from an alkaline cellulase and/or an enzyme having mannanase activity.
17. Composition according to paragraph 16, wherein the composition is a dish wash composition.
18. Composition according to any of paragraphs 16 or 17, wherein the alkaline cellulase is an enzyme exhibiting endo-beta-1,4-glucanase activity (EC 3.2.1.4)
19. Composition according to paragraph 18, wherein the enzyme exhibiting endo-beta-1,4-glucanase activity has at least 80% sequence identity to SEQ ID NO: 1.
20. Composition according to any of paragraphs 16-19, wherein the enzyme having mannanase activity has at least 80% sequence identity to SEQ ID NO: 2.
21. Composition according to any of paragraphs 16-20, wherein the at least one enzyme is used together with an oxidase.
22. Composition according to paragraph 21, wherein the oxidase is a carbohydrate oxidase (EC 1.1.3).
23. Composition according to any of paragraphs 21-22, wherein the carbohydrate oxidase is a glucose oxidase (EC 1.1.3.4), a dehydrogenase or a cellobiose oxidase (EC 1.1.99.18).
24. Composition according to paragraph 23, wherein the glucose oxidase has at least 80% sequence identity to SEQ ID NO 4.
25. Composition according to paragraph 23, wherein the cellobiose oxidase has at least 80% sequence identity to SEQ ID NO: 4.
26. Composition according to any of paragraphs 16-25, wherein the composition comprises one or more enzymes in addition to the at least one enzymes and the oxidase.
27. Composition according to paragraph 26, wherein the composition comprises amylase and/or protease.
28. Composition according to paragraph 27, wherein the amylase is an alpha-amylase or a glucoamylase.
29. Composition according to paragraph 28, wherein the amylase has at least 80% sequence identity to SEQ ID NO: 5.
30. Composition according to paragraph 27, wherein the protease is a serine protease or a metalloprotease, preferably an alkaline microbial protease or a trypsin-like protease.
31. Composition according to paragraph 30, wherein the protease has at least 80% sequence identity to SEQ ID NO: 6 or the protease has at least 80% sequence identity to SEQ ID NO: 7.
32. Composition according to any of the preceding composition paragraphs, wherein the composition further comprises a surfactant.
33. Composition according to any of the preceding composition paragraphs, wherein the composition further comprises one or more builders and one or more polymer.
34. Composition according to any of the preceding composition composition paragraphs, wherein the composition further comprises one or more components selected from the group consisting of polymers, bleaching components, silicates, dyestuff and metal care agents.
35. Composition according to any of paragraphs 33-34, wherein the composition is a dishwashing composition in the form of a powder, a bar, a homogenous tablet, a tablet having two or more layers, a pouch having one or more compartments, a regular or compact powder, a granule, a paste, a gel, or a regular, compact or concentrated liquid.
36. Composition according to any of paragraphs 33-35, wherein the builder wherein the builder is selected among phosphates, sodium citrate builders, sodium carbonate, sodium silicate, sodium and zeolites.
37. Composition according to any of paragraphs 33-36, wherein the builder is added in an amount of about 0-65% by weight, preferably about 40-65% by weight, particularly about 20-65% by weight, particularly from 10% to 50% by weight.
38. Composition according to any of the preceding paragraphs, wherein the composition is phosphate free.
39. Composition according to any of paragraphs 33-38, wherein the builder is selected from citric acid, methyl glycine-N,N-diacetic acid (MGDA) and/or glutamic-N,N-diacetic acid (GLDA) and mixtures thereof.
40. Composition according to any of paragraphs 34-39, wherein wherein the bleach component is selected from bleaching catalysts, photobleaches, bleach activators, sources of hydrogen peroxide such as sodium percarbonate, sodium perborates and hydrogen peroxide, preformed peracids and mixtures thereof.
41. A method for washing an hard surface, wherein the method comprises the steps of:
   (i) Exposing the hard surface to a wash liquor comprising at least one enzyme selected from an alkaline cellulase and/or an enzyme having mannanase activity or the cleaning composition according to any of paragraphs 16-40, and
   (ii) Rinsing the hard surface with water optionally comprising a rinsing aid;
   wherein the hard surface is a dishware or a hard surface.
42. Method according to any of the preceding method paragraphs, wherein the hard surface is a hard surface in the interior of a dishwashing machine or a sink, such as walls, baskets, nozzles, pumps, sump, filters, pipelines, drains, and outlets.
43. Method according to any of paragraphs 41-42, wherein the method is hand dishwashing or automatic dish washing.
44. Method according to any of paragraphs 41-43, wherein the method is for washing or cleaning of dishware.
45. Method according to any of paragraphs 41-44, wherein the alkaline cellulase is an enzyme exhibiting endo-beta-1,4-glucanase activity (EC 3.2.1.4)
46. Method according to paragraph 45, wherein the enzyme exhibiting endo-beta-1,4-glucanase activity has at least 80% sequence identity to SEQ ID NO: 1.
47. Method according to any of the preceding method paragraphs, wherein the enzyme having mannanase activity has at least 80% sequence identity to SEQ ID NO: 2.
48. Method according to any of the preceding method paragraphs, wherein the at least one enzyme is used together with an oxidase.
49. Method according to paragraph 48, wherein the oxidase is a carbohydrate oxidase (EC 1.1.3).
50. Method according to any of paragraphs 48-49, wherein the carbohydrate oxidase is a glucose oxidase (EC 1.1.3.4), a dehydrogenase, a cellobiose oxidase (EC 1.1.99.18)
51. Method according to paragraph 50, wherein the glucose oxidase has at least 80% sequence identity to SEQ ID NO: 3.
52. Method according to paragraph 50, wherein the cellobiose oxidase has at least 80% sequence identity to SEQ ID NO: 4.
53. Method according to any of paragraphs 41-52, wherein the composition comprises one or more enzymes in addition to the at least one enzymes and the oxidase.
54. Method according to paragraph 53, wherein the composition comprises amylase and/or protease.
55. Method according to paragraph 54, wherein the amylase is an alpha-amylase or a glucoamylase.
56. Method according to any of paragraphs 51-55, wherein the amylase has at least 80% sequence identity to SEQ ID NO: 5.
57. Method according to paragraph 54, wherein the protease is chemically modified or protein engineered.
58. Method according to paragraph any of paragraphs 54 and 57, wherein the protease is a serine protease or a metalloprotease, preferably an alkaline microbial protease or a trypsin-like protease.
59. Method according to paragraph 58, wherein the protease has at least 80% sequence identity to SEQ ID NO: 6 or the protease has at least 80% sequence identity to SEQ ID NO: 7.
60. Method according to any of the preceding method paragraphs, wherein the composition further comprises a surfactant.
61. Method according to any of the preceding method paragraphs, wherein the composition further comprises one or more builders and one or more polymer.
62. Method according to any of the preceding method composition paragraphs, wherein the composition further comprises one or more components selected from the group consisting of polymers, bleaching systems, bleach activators, bleach catalysts, silicates, dyestuff and metal care agents.
63. Method according to any of the preceding method paragraphs, wherein the method is an automatic dishwashing method or a method for manual dish washing.

### Detergent Compositions

The present ADW detergent compositions can be used together with the enzymes of the invention.

SUN prof dishwash tablets P K100 HG756: 5-45% oxygen based bleaching agents and less than 5% non-ionic surfactant, phosphonates and polycarboxylates.

SUN—Sunlight Auto Dish Tablet Detergent—Lemon Oxi Work in Progress: Sodium Carbonate Sodium Cholride, Sodium Citrate, Sodium Carbonate Peroxide, Sodium Polycarboxylate, Sodium Silicate, Alcohol Alkoxylate, Enzyme, Water, Perfume, Benzotriazole and Liquiting® Blue HP.

SUN—Sunlight Auto Dish Powder Detergent—Lemon Oxi: Sodium Cholride, Sodium Carbonate, Sodium Silicate, Sodium Polycarboxylate, Sodium Gluconate, Sodium Carbonate peroxide, Alcohol Alkoxylate, Sodium Silicoaluminate, Enzyme, Perfume, Water, Liquitint Yellow and Liquiting® Blue HP.

SUN—Auto Dish Gel Detergent—citrus: Water, Sodium Silicate, Sodium Hypochlorite, Sodium Carbonate, Sodium Polycarboxylate, Sodium Hydroxide, Carbomer, Sodium benzoate, Sulfuric Acid, Fragance.

SUN—Sunlight Ultra Liquid Dish Detergent—Green Apple: Sodium Dedecylbenzenesulfonate, Sodium Laureth Sulfate, Cocamidopropyl Betaine, Sodium Hydroxide, Magnesium Sulfate, Sodium Xylenesulfonate, Alcohol Denatured, Perfume, Methylchloroisothiazolinone, Methylisothiazolinone, Sanolin® Yellow E-2GL and Sanolin® Blue NBL.

Cascade Platinum® Action Pacs®: Powder ingredients: Sodium Carbonate, Sodium Percarbonate, Sodium Silicate, Modified Plyacrylate, Methyl Glycine deacetic Acid (trisodium Salt), Sodium Sulfate, Protease Enzyme, Amylase Enzyme, Alcohol Alkoxylate, Plyethylene glycol, Hydrozincite, Amine Cobalt Salt, Water, Perfumes. Liquid ingredients: Alcohol Alkoxylate, Trideceth-n, Dipropylene glycol, water, glycerine, Acid Red #33 and/or FD&C Yellow #5 and/or Acid Blue 182 and/or Dye Reactive Green 12. Film: Polyvinyl Alcohol Copolymer.

Cascade Gel: Water, Sodium Silicate, Sodium Carbonate, Sodium Sulfonate, Sodium Polyacrylate, Cross-linked polyacrylate, Sodium Benzoate, Sodium Hypocholrite, Zinc Carbonate, Sodium Hydroxide, Nitric acid, Perfume.

Cascade Powder: Sodium Carbonate, Sodium Sulfate, Polyethyleneimine (sulfonated), Sodium

Silicate, Water, Alcohol Alkoxylate, Sodium Percarbonate, Protease Enzyme, Amylase Enzyme, Amine Cobalt Salt and Perfumes.

Assays

Assay I

Analysis of Gas Composition Using E-Nose (GC Headspace).

As part of the testing real food items were incubated overnight after being prepared as outlined under examples. The headspace was allowed to accumulate in gas vials and the headspace from the 2 mL analyzed from the capped vials in a Heracles II Flash Gas Chromatography Electronic nose from Alpha M.O.S., France (double column gas chromatograph with 2 FIDs, column 1: MXT5 and column 2: MXT1701) after 20 minutes incubation at 40° C.

Assay II

Odor Removal (Sensory Analysis)

After being prepared as outlined under examples and incubated overnight, the vials were then allowed to develop malodor over an additional 2 days to allow for an odor panel to evaluate. The odor panel consists of trained panelists, who were presented with a blind evaluation. T. The odor panel this time was asked to rank the odor from 1 to 5, where 5 was the most pungent odor, and 1 was not significantly different from the blank odor.

### Examples

Preparation of Foodstuffs for Odor Generation

The following foods were identified to be likely causes of malodor in automatic dishwashing machines. Broccoli, Egg, Fish, Onion, and Garlic. Foods were purchased from a local supermarket (Netto, Bagsværd) and initially prepared in the following manner.

Fresh Broccoli: 2 florets of broccoli were covered in water and boiled for 10 min. The broccoli was rinsed in cold water and left to cool. The 2 florets were blended to homogeneity using a hand blender and collected in a petri dish for processing.

Eggs: 1-2 eggs were fried is hot sun flower oil for 1.5 min each side to the appearance of “sunny side up” (yolk slightly runny, not a hard yolk).

Garlic and Onion were untreated and used raw after peeling.

The Fish was purchased as a processed Fishball (Bådsmand Fiskedeller) and one half of one ball processed to homogeneity in the hand blender.

Processing of Foodstuff after Initial Preparation.

Assay Buffer: Buffer pH 8.00. 50 mM HEPES, 50 mM CHES, 1 mM CaCl₂), 0.01% triton X-100.

Water hardness at 21° dH was added to the buffer. The Ca:NaHCO₃:Mg ratio was 4:2:1, prepared using 4000° dH CaCl₂), 2000° dH MgCl2 stock solutions and freshly prepared 0.535 M NaHCO₃.

All the initially prepared food were treated as described below in order to obtain substrate to be tested:
5 g of blended food as prepared above was added to 100 mL of assay buffer and mixed to a fine liquid suspension (ca. 3 min of blending using a handheld 600 watt turbo Braun blender).
8 replicates of 2 mL were pipetted to a 20 mL GC headspace vial. To 4 replicates the enzymes were added, and the other 4 served as a control.
Each foodsample was prepared individually first and after pipetting the lids screwed tightly in place.
The vials were mixed using a whirl mixer for 30 s at 2500 rpm.
Controls are listed below.
GC Vials were prepared with buffer alone and with buffer and enzymes only but without food to serve as background gas controls.
All vials were incubated at 37° C. over 24 h.

TABLE 1
Experimental setup

| Label | Food | Enzymes | Comment |
|---|---|---|---|
| A 1-4 | None | None | Control |
| B 1-4 | None | All | Control |
| C 1-4 | None | All (SEQ 6) | Control |
| D 1-4 | Egg | None | Control |
| E 1-4 | Garlic | None | Control |
| F 1-4 | Onion | None | Control |
| G 1-4 | Fish | None | Control |
| H 1-4 | Broccoli | None | Control |
| I 1-4 | Egg | All (SEQ 6) | |
| J 1-4 | Garlic | ALL | |
| K 1-4 | Onion | ALL | |
| L 1-4 | Fish | ALL | |
| M 1-4 | Broccoli | ALL | |

None means that no enzymes are added. All means that enzymes SEQ ID NO: 1, 2, 4, 5 and 7 were added in the below concentrations. All (SEQ 6) means that enzymes SEQ ID NO: 1, 2, 4, 5 and 6 were added

TABLE 2

| Enzyme | mg/L in assay |
|---|---|
| SEQ ID NO: 1 | 0.1 |
| SEQ ID NO: 2 | 30.8 |
| SEQ ID NO: 4 | 105.0 |
| SEQ ID NO: 6 | 6.4 |
| SEQ ID NO: 7 | 6.5 |
| SEQ ID NO: 5 | 36.4 |

### Example 1

The experimental set up is shown tables 1-2 above.

Analysis of Gas Composition Using E-Nose (Assay I).

As part of the testing real food items were incubated overnight after being prepared as outlined above. The headspace was allowed to accumulate in gas vials and the headspace from the 2 mL analyzed from the capped vials in a Heracles II Flash Gas Chromatography Electronic nose from Alpha M.O.S., France (double column gas chromatograph with 2 FIDs, column 1: MXT5 and column 2: MXT1701) after 20 minutes incubation at 40° C.

Evaluation of Odor Removal

After overnight incubation, the foodstuffs were analyzed by E-Nose as described above; the vials were then allowed to develop malodor over an additional 2 d to allow for an odor panel to evaluate. The odor panel consist of 5 trained panelist, who were presented with a blind evaluation. The panelists were asked to evaluate the difference in malodor on a scale of N/A to +++, where N/A was not applicable due to over generation of scent in both control and enzyme treated vials, and the difference if detected could be ranked thusly:

| Symbol | Key |
|---|---|
| +++ | Almost no residual gas/odour left |
| ++ | Very slight gas/odour remaining |
| N/A | Out of range |

These results were compared to the E-Nose data where the integral of the areas was used to determine large differences.

| | E-Nose: | Panel: |
|---|---|---|
| | Gas | Odor |
| Food | Reduction | Reduction |
| Broccoli | +++ | +++ |
| Fish | +++ | +++ |
| Onion | N/A | N/A |
| Egg | ++ | +++ |
| Garlic | N/A | N/A |

Neither onion nor Garlic could be evaluated due to the signal being too high for both the E-nose and the panelists.

TABLE 3
GC Headspace retention measurements for food items with and without enzymes. Channel 1, a cutoff value of
10,000 was chosen to pick the most relevant peaks, similar trends were seen in channel 2 (data not shown).

| GC HeadSpace Retention | 11.87-1- | 12.03-1- | 12.16-1- | 12.74-1- | 13.89-1- | 14.03-1- | 15.07-1- | 16.99-1- |
|---|---|---|---|---|---|---|---|---|
| Time-Channel 1 | A | A | A | A | A | A | A | A |
| Buffer only Ctrl | 0 | 0 | 0 | 3949 | 0 | 0 | 628 | 355 |
| All in buffer Ctrl | 0 | 0 | 0 | 4229 | 0 | 0 | 5346 | 6653 |
| All (SEQ 6) in buffer Ctrl | 0 | 0 | 0 | 4270 | 0 | 0 | 3583 | 5464 |
| Egg in buffer | 0 | 0 | 0 | 4003 | 363 | 528 | 3290 | 17687 |
| Garlic in buffer | 1125611 | 0 | 1182473 | 0 | 0 | 0 | 0 | 220742 |
| Onion in buffer | 0 | 0 | 0 | 18071 | 0 | 2615 | 44361 | 213736 |
| Fish in buffer | 0 | 0 | 0 | 8749 | 0 | 0 | 41483 | 7217 |
| Broccoli in buffer | 0 | 0 | 0 | 3828 | 22626 | 15037 | 0 | 1464 |
| Egg with All (SEQ 6) | 0 | 0 | 0 | 4095 | 0 | 0 | 4312 | 5941 |
| Garlic with All | 485915 | 497499 | 0 | 916651 | 0 | 0 | 15269 | 192084 |
| Onion with All | 0 | 0 | 0 | 16537 | 0 | 0 | 6596 | 229689 |
| Fish with All | 25 | 0 | 0 | 6489 | 0 | 0 | 5001 | 28035 |
| Broccoli with All | 0 | 0 | 0 | 9590 | 0 | 0 | 5917 | 10958 |
| GC HeadSpace Retention | 17.52-1- | 18.57-1- | 18.94-1- | 21.17-1- | 22.27-1- | 26.88-1- | 28.45-1- | 30.06-1- |
| Time-Channel 1 | A | A | A | A | A | A | A | A |
| Buffer only Ctrl | 0 | 0 | 0 | 10676 | 0 | 240 | 0 | 0 |
| All in buffer Ctrl | 0 | 0 | 0 | 11466 | 0 | 732 | 118 | 0 |
| All (SEQ 6) in buffer Ctrl | 0 | 0 | 897 | 8454 | 0 | 640 | 0 | 0 |
| Egg in buffer | 0 | 0 | 0 | 10602 | 0 | 663 | 54 | 0 |
| Garlic in buffer | 0 | 37560 | 39058 | 179301 | 0 | 452650 | 0 | 237232 |
| Onion in buffer | 0 | 0 | 0 | 7810 | 40585 | 3221 | 93060 | 0 |
| Fish in buffer | 1073 | 1892 | 4037 | 13502 | 0 | 1811 | 1463 | 0 |
| Broccoli in buffer | 0 | 0 | 94909 | 16448 | 0 | 1687 | 302 | 0 |
| Egg with All (SEQ 6) | 0 | 0 | 1226 | 11016 | 0 | 665 | 102 | 0 |
| Garlic with All | 0 | 16191 | 36397 | 185402 | 0 | 398142 | 0 | 240635 |
| Onion with All | 77881 | 0 | 0 | 12363 | 4787 | 2087 | 10948 | 0 |
| Fish with All | 0 | 0 | 0 | 9100 | 0 | 1346 | 0 | 0 |
| Broccoli with All | 0 | 0 | 4124 | 11274 | 0 | 5198 | 164 | 0 |
| GC HeadSpace Retention | 34.06-1- | 36.40-1- | 38.18-1- | 44.88-1- | 54.38-1- | 56.63-1- | 69.88-1- | 77.50-1- |
| Time-Channel 1 | A | A | A | A | A | A | A | A |
| Buffer only Ctrl | 0 | 0 | 0 | 1551 | 0 | 251 | 244 | 0 |
| All in buffer Ctrl | 0 | 173 | 134 | 1522 | 0 | 1346 | 145 | 0 |
| All (SEQ 6) in buffer Ctrl | 0 | 110 | 110 | 1498 | 0 | 1260 | 172 | 0 |
| Egg in buffer | 0 | 1599 | 1276 | 3001 | 8547 | 2161 | 6351 | 0 |
| Garlic in buffer | 62324 | 0 | 37158 | 252484 | 1126 | 35733 | 21430 | 824 |
| Onion in buffer | 99 | 0 | 37 | 3954 | 92 | 117007 | 1074 | 17971 |
| Fish in buffer | 0 | 3331 | 1293 | 1723 | 22259 | 3349 | 602 | 113 |
| Broccoli in buffer | 0 | 0 | 409 | 4225 | 34 | 298734 | 860 | 0 |
| Egg with All (SEQ 6) | 0 | 1017 | 531 | 2095 | 22 | 5365 | 1057 | 0 |
| Garlic with All | 30806 | 15894 | 38259 | 232711 | 1747 | 46476 | 60232 | 804 |
| Onion with All | 50 | 590 | 515 | 1953 | 0 | 16481 | 1101 | 21868 |
| Fish with All | 0 | 1571 | 1700 | 2173 | 36 | 7481 | 2169 | 780 |
| Broccoli with All | 0 | 634 | 300 | 31935 | 0 | 3640 | 1091 | 0 |
| GC HeadSpace Retention | 83.31-1- | 85.96-1- | 88.63-1- | 90.71-1- | 92.36-1- | 94.70-1- | 97.18-1- | 99.10-1- |
| Time-Channel 1 | A | A | A | A | A | A | A | A |
| Buffer only Ctrl | 0 | 0 | 203 | 1734 | 0 | 0 | 240 | 176 |
| All in buffer Ctrl | 16 | 18 | 228 | 1542 | 0 | 0 | 520 | 182 |
| All (SEQ 6) in buffer Ctrl | 13 | 65 | 220 | 1551 | 0 | 0 | 307 | 154 |
| Egg in buffer | 0 | 2320 | 493 | 2325 | 0 | 0 | 125 | 164 |
| Garlic in buffer | 1744985 | 19533 | 136277 | 75352 | 77217 | 1151297 | 32141 | 204010 |
| Onion in buffer | 791 | 3505 | 199 | 1418 | 2021 | 11674 | 345581 | 22052 |
| Fish in buffer | 237 | 227 | 482 | 1331 | 103 | 51 | 546 | 97 |
| Broccoli in buffer | 139 | 0 | 215 | 1585 | 0 | 912 | 206 | 624 |
| Egg with All (SEQ 6) | 0 | 117 | 118 | 2138 | 0 | 0 | 190 | 135 |
| Garlic with All | 1915336 | 17607 | 166169 | 87537 | 130011 | 915011 | 40447 | 273854 |
| Onion with All | 1044 | 1191 | 266 | 2091 | 3027 | 3086 | 88181 | 31242 |
| Fish with All | 264 | 229 | 178 | 2904 | 144 | 47 | 602 | 128 |
| Broccoli with All | 176 | 70 | 121 | 2177 | 0 | 118 | 174 | 155 |

| GC HeadSpace Retention | 102.86- | 105.84- | 129.34- | 159.06- | 188.44- |
|---|---|---|---|---|---|
| Time-Channel 1 | 1-A | 1-A | 1-A | 1-A | 1-A |
| Buffer only Ctrl | 340 | 2514 | 5738 | 13325 | 3686 |
| All in buffer Ctrl | 386 | 5563 | 5062 | 18778 | 2171 |
| All (SEQ 6) in buffer Ctrl | 365 | 3207 | 5170 | 15306 | 1799 |
| Egg in buffer | 349 | 3624 | 4710 | 9146 | 1582 |
| Garlic in buffer | 936179 | 0 | 2498891 | 3516955 | 234935 |
| Onion in buffer | 2905 | 35732 | 488812 | 214933 | 25010 |
| Fish in buffer | 576 | 6296 | 9820 | 19769 | 2069 |
| Broccoli in buffer | 491 | 5367 | 6442 | 10633 | 1502 |
| Egg with All (SEQ 6) | 152 | 1989 | 4243 | 15925 | 1216 |
| Garlic with All | 702074 | 21502 | 4110087 | 3378480 | 258596 |
| Onion with All | 2625 | 10597 | 233400 | 102226 | 14717 |
| Fish with All | 837 | 4473 | 11156 | 28055 | 1980 |
| Broccoli with All | 489 | 2792 | 6568 | 18034 | 1423 |

### Example 2

Example 1 was repeated with the following differences: the Onion and Garlic were processed at 25 mg/2 mL. The experimental set up is shown tables 1-2 above.

Data from Assay I can be found in table 4 below.

TABLE 4
Assay I: GC Headspace retention measurements for food items with and without enzymes. Channel 1, a cutoff value
of 10,000 was chosen to pick the most relevant peaks, similar trends were seen in channel 2 (data not shown).

| GC HeadSpace Retention | 12.33-1- | 12.45-1- | 12.60-1- | 14.43-1- | 15.84-1- | 17.32-1- | 17.44-1- | 18.46-1- |
|---|---|---|---|---|---|---|---|---|
| Time-Channel 1 | A | A | A | A | A | A | A | A |
| Buffer only Ctrl | 0 | 0 | 0 | 0 | 368 | 0 | 0 | 13758 |
| All in buffer Ctrl | 0 | 0 | 0 | 2994 | 9263 | 0 | 0 | 15193 |
| All (SEQ 6) in buffer Ctrl | 0 | 0 | 0 | 3074 | 9215 | 0 | 0 | 15515 |
| Egg in buffer | 0 | 0 | 0 | 5178 | 2283 | 0 | 0 | 15147 |
| Garlic in buffer | 114467 | 317782 | 0 | 0 | 67904 | 0 | 0 | 40664 |
| Onion in buffer | 0 | 0 | 0 | 0 | 56685 | 0 | 0 | 10686 |
| Fish in buffer | 0 | 0 | 0 | 366929 | 0 | 0 | 0 | 12137 |
| Broccoli in buffer | 0 | 0 | 0 | 32100 | 0 | 78289 | 26344 | 0 |
| Egg with All (SEQ 6) | 0 | 0 | 0 | 3507 | 10315 | 0 | 0 | 13053 |
| Garlic with All | 0 | 165671 | 54238 | 0 | 59851 | 0 | 0 | 33880 |
| Onion with All | 0 | 0 | 0 | 3487 | 105256 | 0 | 0 | 23924 |
| Fish with All | 0 | 0 | 0 | 5549 | 32913 | 0 | 0 | 13997 |
| Broccoli with All | 0 | 0 | 0 | 4571 | 15139 | 0 | 0 | 15743 |
| GC HeadSpace Retention | 18.90-1- | 19.39-1- | 20.45-1- | 22.77-1- | 24.45-1- | 25.51-1- | 37.35-1- | 44.94-1- |
| Time-Channel 1 | A | A | A | A | A | A | A | A |
| Buffer only Ctrl | 0 | 0 | 0 | 700 | 0 | 0 | 0 | 0 |
| All in buffer Ctrl | 0 | 0 | 0 | 1103 | 0 | 0 | 0 | 0 |
| All (SEQ 6) in buffer Ctrl | 0 | 0 | 0 | 1234 | 0 | 0 | 0 | 0 |
| Egg in buffer | 0 | 0 | 0 | 1149 | 0 | 0 | 1227 | 1681 |
| Garlic in buffer | 0 | 0 | 0 | 96821 | 0 | 40173 | 37774 | 0 |
| Onion in buffer | 0 | 20194 | 0 | 1458 | 27290 | 0 | 0 | 0 |
| Fish in buffer | 0 | 21596 | 0 | 4020 | 7163 | 0 | 8754 | 10496 |
| Broccoli in buffer | 0 | 0 | 0 | 803 | 0 | 0 | 6778 | 1764 |
| Egg with All (SEQ 6) | 0 | 0 | 0 | 866 | 0 | 0 | 0 | 0 |
| Garlic with All | 12027 | 0 | 0 | 62820 | 0 | 24526 | 30472 | 0 |
| Onion with All | 0 | 0 | 0 | 1588 | 6767 | 0 | 85 | 0 |
| Fish with All | 0 | 0 | 15346 | 0 | 0 | 0 | 3348 | 0 |
| Broccoli with All | 0 | 0 | 0 | 8136 | 0 | 0 | 25140 | 0 |
| GC HeadSpace Retention | 47.47-1- | 58.24-1- | 70.53-1- | 75.42-1- | 77.24-1- | 79.42-1- | 81.22-1- | 84.03-1- |
| Time-Channel 1 | A | A | A | A | A | A | A | A |
| Buffer only Ctrl | 0 | 184 | 0 | 261 | 1743 | 15 | 0 | 53 |
| All in buffer Ctrl | 0 | 152 | 0 | 140 | 1156 | 15 | 0 | 126 |
| All (SEQ 6) in buffer Ctrl | 0 | 148 | 0 | 270 | 1674 | 0 | 0 | 132 |
| Egg in buffer | 247 | 2513 | 0 | 254 | 1904 | 0 | 0 | 104 |
| Garlic in buffer | 11946 | 6596 | 324772 | 17996 | 18052 | 10348 | 190882 | 7091 |
| Onion in buffer | 3092 | 223 | 255 | 179 | 1219 | 379 | 1562 | 19836 |
| Fish in buffer | 0 | 5971 | 82 | 280 | 1052 | 31 | 55 | 1278 |
| Broccoli in buffer | 30284 | 2180 | 0 | 686 | 1648 | 16 | 95 | 317 |
| Egg with All (SEQ 6) | 0 | 1865 | 0 | 177 | 2063 | 31 | 0 | 172 |
| Garlic with All | 11183 | 11158 | 252367 | 11225 | 12751 | 7712 | 120800 | 4657 |
| Onion with All | 0 | 1379 | 211 | 249 | 1549 | 359 | 189 | 2876 |
| Fish with All | 0 | 5678 | 81 | 333 | 3109 | 38 | 0 | 739 |
| Broccoli with All | 0 | 1720 | 15 | 214 | 2206 | 0 | 0 | 203 |
| GC HeadSpace Retention | 85.37-1- | 89.06-1- | 109.13- | 114.62- | 118.39- | 123.45- | 129.00- | 137.22- |
| Time-Channel 1 | A | A | 1-A | 1-A | 1-A | 1-A | 1-A | 1-A |
| Buffer only Ctrl | 323 | 556 | 5852 | 1790 | 1019 | 710 | 3654 | 1076 |
| All in buffer Ctrl | 312 | 623 | 5516 | 1630 | 841 | 228 | 10280 | 919 |
| All (SEQ 6) in buffer Ctrl | 314 | 695 | 5769 | 1620 | 1255 | 180 | 11184 | 761 |
| Egg in buffer | 316 | 512 | 6289 | 1555 | 569 | 233 | 1918 | 712 |
| Garlic in buffer | 33171 | 193008 | 3130042 | 76838 | 36723 | 72911 | 75586 | 159679 |
| Onion in buffer | 3942 | 808 | 64165 | 20089 | 38742 | 585 | 3101 | 1183 |
| Fish in buffer | 250 | 863 | 7392 | 2012 | 426 | 190 | 1854 | 956 |
| Broccoli in buffer | 482 | 635 | 5308 | 1545 | 433 | 177 | 2527 | 815 |
| Egg with All (SEQ 6) | 317 | 677 | 6009 | 1718 | 630 | 323 | 13123 | 653 |
| Garlic with All | 25049 | 102954 | 2978852 | 45903 | 17777 | 35537 | 58083 | 96108 |
| Onion with All | 1174 | 877 | 23147 | 7519 | 1989 | 572 | 12976 | 1753 |
| Fish with All | 293 | 896 | 12225 | 3231 | 472 | 611 | 13520 | 2790 |
| Broccoli with All | 295 | 964 | 5648 | 2380 | 377 | 471 | 12934 | 1211 |

| GC HeadSpace Retention | 143.24- | 154.28- | 169.95- | 191.97- | 215.61- | 218.92- | 229.13- |
|---|---|---|---|---|---|---|---|
| Time-Channel 1 | 1-A | 1-A | 1-A | 1-A | 1-A | 1-A | 1-A |
| Buffer only Ctrl | 1717 | 4478 | 1819 | 8656 | 0 | 0 | 0 |
| All in buffer Ctrl | 1747 | 5068 | 1845 | 7366 | 0 | 0 | 0 |
| All (SEQ 6) in buffer Ctrl | 1761 | 5122 | 1959 | 8306 | 0 | 0 | 0 |
| Egg in buffer | 1140 | 4204 | 704 | 7062 | 0 | 0 | 0 |
| Garlic in buffer | 71647 | 88584 | 27466 | 23567 | 1855825 | 0 | 908875 |
| Onion in buffer | 75943 | 5797 | 4409 | 10753 | 527175 | 0 | 2612 |
| Fish in buffer | 2052 | 9444 | 709 | 6980 | 0 | 0 | 661775 |
| Broccoli in buffer | 1593 | 5464 | 1010 | 7032 | 13406 | 0 | 2672 |
| Egg with All (SEQ 6) | 1019 | 3929 | 816 | 5495 | 0 | 0 | 3385 |
| Garlic with All | 47660 | 52839 | 17170 | 20449 | 3769 | 0 | 1711225 |
| Onion with All | 12650 | 6056 | 2121 | 9793 | 620925 | 228725 | 2826 |
| Fish with All | 2179 | 9386 | 734 | 7549 | 0 | 0 | 260025 |
| Broccoli with All | 1162 | 4835 | 656 | 7448 | 1097125 | 0 | 0 |

### Example 3

In addition to example 2, a parallel trial was set up to determine which enzymes performed the odor reduction most effectively.

Broccoli, fish and egg as well as a background buffer blank was set up in the following manner

TABLE 5
showing Individual enzyme analysis

| | | | Manna- | Cellu- | |
|---|---|---|---|---|---|
| | | | nase | lase | Oxidase |
| | | | SEQ ID | SEQ ID | SEQ ID |
| Label | Food | Enzymes | NO: 2 | NO: 1 | NO: 4 |
| XX A 1-4 | Differs | None | | | |
| XX B 1-4 | Differs | Protease (SEQ ID | | | |
| | | NO: 6 or 7) + | | | |
| | | Amylase (SEQ ID | | | |
| | | NO: 5) | | | |
| XX C 1-4 | Differs | Protease (SEQ ID | X | | |
| | | NO: 6 or 7) + | | | |
| | | Amylase (SEQ ID | | | |
| | | NO: 5) | | | |
| XX D 1-4 | Differs | Protease (SEQ ID | | X | |
| | | NO: 6 or 7) + | | | |
| | | Amylase (SEQ ID | | | |
| | | NO: 5) | | | |
| XX E 1-4 | Differs | Protease (SEQ ID | | | X |
| | | NO: 6 or 7) + | | | |
| | | Amylase (SEQ ID | | | |
| | | NO: 5) | | | |
| XX F 1-4 | Differs | Protease (SEQ ID | X | X | |
| | | NO: 6 or 7) + | | | |
| | | Amylase (SEQ ID | | | |
| | | NO: 5) | | | |
| XX G 1-4 | Differs | Protease (SEQ ID | | X | X |
| | | NO: 6 or 7) + | | | |
| | | Amylase (SEQ ID | | | |
| | | NO: 5) | | | |
| XX H 1-4 | Differs | Protease (SEQ ID | X | X | X |
| | | NO: 6 or 7) + | | | |
| | | Amylase (SEQ ID | | | |
| | | NO: 5) | | | |

E.g. Labels for control was called None, and labeled NO A1-4 etc.

Egg=EG, Broccoli=BR, Fish=FI. When the foodstuff is egg the protease of SEQ ID NO: 6 is used. When the foodstuff is not egg the protease of SEQ ID NO: 7 is used.

Odor Panel evaluation of Results (Assay II). The odor panel this time was asked to rank the odor from 1 to 5, where 5 was the most pungent odor, and 1 was not significantly different from the blank odor. The odor panel consisted of 5 trained panelists. Data can be found in table 9. Data from Assay I can be found in tables 6-8.

The foodstuffs were prepared and processed as described above in paragraphs “Preparation of foodstuffs for odor generation” and “Processing of foodstuff after initial preparation” and with the experimental setup describe above. One experiment is performed with a commercial detergent composition instead of buffer, where 1 tablet of SUN prof dishwash tablets P K100 HG756 is dissolved in 5 L water instead of buffer. The composition of SUN prof dishwash tablets P K100 HG756 is: 5-15% oxygen based bleaching agents and less than 5% non-ionic surfactant, phosphonates and polycarboxylates. The tablets were used to determine a fragrance masking profile instead of an odor removal. No enzymes were added to the tablet prepared foodstuffs.

TABLE 6
Assay I: GC Headspace retention measurements for Broccoli with different enzymes. Channel 1, a cutoff
value of 5,000 was chosen to pick the most relevant peaks, similar trends were seen in channel 2 (data not shown).

| | 13.01- | 14.39- | 15.66- | 16.00- | 17.19- | 18.36- | 19.50- | 22.65- |
|---|---|---|---|---|---|---|---|---|
| GC HeadSpace Retention Time-Channel 1 | 1-A | 1-A | 1-A | 1-A | 1-A | 1-A | 1-A | 1-A |
| Broccoli in Buffer background | 3915 | 53666 | 0 | 1177 | 10023 | 23594 | 0 | 1800 |
| Broccoli + protease and amylase | 6434 | 0 | 0 | 3497 | 5988 | 17821 | 0 | 1791 |
| Broccoli + protease, amylase, mannanase | 7727 | 17077 | 0 | 2520 | 6520 | 17532 | 0 | 4284 |
| Broccoli + protease, amylase, cellulose | 5860 | 46750 | 0 | 1409 | 13000 | 23542 | 0 | 1810 |
| Broccoli + protease, amylase, oxidase | 6938 | 4823 | 0 | 11650 | 6411 | 16323 | 0 | 8792 |
| Broccoli + protease, amylase, cellulase, | 7212 | 0 | 0 | 3366 | 5200 | 15193 | 0 | 4937 |
| mannanase | | | | | | | | |
| Broccoli + protease, amylase, cellulase, oxidase | 5708 | 4276 | 0 | 10305 | 5903 | 15104 | 5123 | 8074 |
| Broccoli + protease, amylase, mannanase, | 7342 | 5111 | 0 | 10854 | 5613 | 15913 | 0 | 7457 |
| oxidase | | | | | | | | |
| Broccoli + protease, amylase, mannanase, | 5545 | 4382 | 0 | 8827 | 4076 | 15143 | 0 | 6055 |
| cellulase, oxidase | | | | | | | | |
| Broccoli in Tablet | 11730 | 0 | 0 | 3458 | 3311 | 17117 | 0 | 4146 |
| | 37.30- | 45.74- | 47.21- | 48.91- | 51.53- | 58.07- | 62.11- | 77.04- |
| GC HeadSpace Retention Time-Channel 1 | 1-A | 1-A | 1-A | 1-A | 1-A | 1-A | 1-A | 1-A |
| Broccoli in Buffer background | 5157 | 42 | 18913 | 1200 | 7282 | 2511 | 6364 | 3580 |
| Broccoli + protease and amylase | 4935 | 5482 | 0 | 2230 | 5047 | 2033 | 6491 | 2596 |
| Broccoli + protease, amylase, mannanase | 40159 | 20160 | 0 | 5051 | 4255 | 3081 | 6879 | 1891 |
| Broccoli + protease, amylase, cellulase | 4961 | 6394 | 0 | 2576 | 5160 | 1735 | 7215 | 1751 |
| Broccoli + protease, amylase, oxidase | 50814 | 6079 | 0 | 2339 | 2270 | 2525 | 7735 | 2425 |
| Broccoli + protease, amylase, cellulase, | 51099 | 18209 | 0 | 4644 | 3494 | 3867 | 7190 | 2003 |
| mannanase | | | | | | | | |
| Broccoli + protease, amylase, cellulase, oxidase | 46165 | 8606 | 0 | 2841 | 2296 | 2458 | 7423 | 2141 |
| Broccoli + protease, amylase, mannanase, | 40817 | 16123 | 0 | 4439 | 3013 | 2805 | 8335 | 2182 |
| oxidase | | | | | | | | |
| Broccoli + protease, amylase, mannanase, | 32176 | 7514 | 0 | 2509 | 1741 | 1890 | 7740 | 1639 |
| cellulase, oxidase | | | | | | | | |
| Broccoli in Tablet | 85573 | 1651 | 0 | 1515 | 1818 | 7252 | 7929 | 9835 |
| | 96.20- | 99.24- | 104.97- | 107.91- | 112.32- | 118.04- | 128.85- | 133.99- |
| GC HeadSpace Retention Time-Channel 1 | 1-A | 1-A | 1-A | 1-A | 1-A | 1-A | 1-A | 1-A |
| Broccoli in Buffer background | 131 | 760 | 1423 | 1266 | 25 | 644 | 1261 | 285 |
| Broccoli + protease and amylase | 169 | 609 | 770 | 1127 | 0 | 640 | 4879 | 273 |
| Broccoli + protease, amylase, mannanase | 517 | 675 | 546 | 979 | 0 | 533 | 16843 | 120 |
| Broccoli + protease, amylase, cellulase | 226 | 640 | 641 | 851 | 0 | 492 | 6784 | 396 |
| Broccoli + protease, amylase, oxidase | 168 | 774 | 532 | 964 | 0 | 429 | 6600 | 248 |
| Broccoli + protease, amylase, cellulase, | 453 | 1002 | 649 | 854 | 0 | 536 | 12515 | 190 |
| mannanase | | | | | | | | |
| Broccoli + protease, amylase, cellulase, oxidase | 143 | 961 | 487 | 828 | 0 | 446 | 7033 | 113 |
| Broccoli + protease, amylase, mannanase, | 250 | 942 | 1654 | 1027 | 193 | 693 | 16334 | 265 |
| oxidase | | | | | | | | |
| Broccoli + protease, amylase, mannanase, | 29 | 1024 | 405 | 904 | 0 | 493 | 11464 | 181 |
| cellulase, oxidase | | | | | | | | |
| Broccoli in Tablet | 38638 | 71296 | 179156 | 18459 | 24561 | 23836 | 21949 | 5004 |

| | 141.96- | 147.41- | 155.13- | 159.93- | 191.32- |
|---|---|---|---|---|---|
| GC HeadSpace Retention Time-Channel 1 | 1-A | 1-A | 1-A | 1-A | 1-A |
| Broccoli in Buffer background | 238 | 408 | 1762 | 1533 | 7718 |
| Broccoli + protease and amylase | 155 | 47 | 1704 | 1582 | 7358 |
| Broccoli + protease, amylase, mannanase | 139 | 0 | 1801 | 1696 | 7348 |
| Broccoli + protease, amylase, cellulase | 177 | 0 | 1948 | 1628 | 7205 |
| Broccoli + protease, amylase, oxidase | 110 | 0 | 1521 | 1795 | 6923 |
| Broccoli + protease, amylase, cellulase, | 41 | 0 | 1641 | 1838 | 6770 |
| mannanase | | | | | |
| Broccoli + protease, amylase, cellulase, oxidase | 72 | 0 | 1509 | 1983 | 6351 |
| Broccoli + protease, amylase, mannanase, | 159 | 631 | 1667 | 2051 | 6372 |
| oxidase | | | | | |
| Broccoli + protease, amylase, mannanase, | 103 | 0 | 1391 | 1921 | 6351 |
| cellulase, oxidase | | | | | |
| Broccoli in Tablet | 7863 | 36287 | 15596 | 6251 | 6682 |

TABLE 7
Assay I: GC Headspace retention measurements for Egg with different enzymes. Channel 1, a cutoff value
of 5,000 was chosen to pick the most relevant peaks, similar trends were seen in channel 2 (data not shown).

| GC HeadSpace Retention | 14.48- | 15.92- | 18.46- | 20.01- | 21.54- | 30.34- | 45.00- | 46.08- |
|---|---|---|---|---|---|---|---|---|
| Time-Channel 1 | 1-A | 1-A | 1-A | 1-A | 1-A | 1-A | 1-A | 1-A |
| Egg in Buffer background | 38632 | 0 | 11091 | 0 | 0 | 907 | 5961 | 1735 |
| Egg + protease and amylase | 0 | 6322 | 9377 | 0 | 0 | 169 | 0 | 12917 |
| Egg + protease, amylase, mannanase | 3571 | 527675 | 7125 | 92912 | 24445 | 131 | 0 | 29410 |
| Egg + protease, amylase, cellulase | 0 | 10833 | 9090 | 0 | 0 | 188 | 0 | 8895 |
| Egg + protease, amylase, oxidase | 2845 | 10685 | 10328 | 0 | 0 | 818 | 0 | 21041 |
| Egg + protease, amylase, cellulase, | 0 | 5619 | 9191 | 0 | 0 | 325 | 0 | 37567 |
| mannanase | | | | | | | | |
| Egg + protease, amylase, cellulase, | 2576 | 9205 | 9836 | 0 | 0 | 895 | 0 | 9481 |
| oxidase | | | | | | | | |
| Egg + protease, amylase, mannanase, | 3245 | 11251 | 9699 | 0 | 0 | 1981 | 0 | 16306 |
| oxidase | | | | | | | | |
| Egg + protease, amylase, mannanase, | 2893 | 10498 | 10772 | 0 | 0 | 1838 | 0 | 13809 |
| cellulase, oxidase | | | | | | | | |
| Egg in Tablet | 0 | 3246 | 13446 | 0 | 0 | 6092 | 288 | 1459 |
| GC HeadSpace Retention | 47.14- | 49.15- | 58.37- | 60.44- | 62.36- | 65.21- | 77.36- | 84.25- |
| Time-Channel 1 | 1-A | 1-A | 1-A | 1-A | 1-A | 1-A | 1-A | 1-A |
| Egg in Buffer background | 0 | 1396 | 2437 | 0 | 7744 | 0 | 649 | 80 |
| Egg + protease and amylase | 0 | 4334 | 1634 | 0 | 8282 | 0 | 668 | 71 |
| Egg + protease, amylase, mannanase | 42767 | 7722 | 4551 | 2431 | 7333 | 34602 | 797 | 105 |
| Egg + protease, amylase, cellulase | 0 | 2124 | 1770 | 0 | 7086 | 122 | 611 | 70 |
| Egg + protease, amylase, oxidase | 0 | 5478 | 3215 | 48 | 7646 | 0 | 1638 | 118 |
| Egg + protease, amylase, cellulase, | 0 | 9401 | 5414 | 186 | 8230 | 0 | 721 | 89 |
| mannanase | | | | | | | | |
| Egg + protease, amylase, cellulase, | 0 | 3220 | 3616 | 0 | 8280 | 0 | 1737 | 105 |
| oxidase | | | | | | | | |
| Egg +protease, amylase, mannanase, | 0 | 4801 | 4761 | 19 | 8354 | 0 | 2002 | 152 |
| oxidase | | | | | | | | |
| Egg + protease, amylase, mannanase, | 0 | 3966 | 4300 | 22 | 8435 | 0 | 1712 | 124 |
| cellulase, oxidase | | | | | | | | |
| Egg in Tablet | 0 | 1233 | 17270 | 0 | 8451 | 0 | 14501 | 8393 |
| GC HeadSpace Retention | 87.21- | 92.49- | 97.13- | 99.40- | 104.08- | 109.05- | 112.62- | 128.48- |
| Time-Channel 1 | 1-A | 1-A | 1-A | 1-A | 1-A | 1-A | 1-A | 1-A |
| Egg in Buffer background | 1079 | 6833 | 180 | 754 | 513 | 3559 | 0 | 1360 |
| Egg + protease and amylase | 851 | 6078 | 186 | 651 | 293 | 3644 | 0 | 6165 |
| Egg + protease, amylase, mannanase | 820 | 5667 | 137 | 646 | 381 | 3851 | 0 | 22389 |
| Egg + protease, amylase, cellulase | 728 | 5099 | 135 | 632 | 170 | 3086 | 0 | 4474 |
| Egg + protease, amylase, oxidase | 682 | 5711 | 146 | 800 | 198 | 3565 | 0 | 7306 |
| Egg + protease, amylase, cellulase, | 746 | 5505 | 120 | 408 | 242 | 3271 | 0 | 14595 |
| mannanase | | | | | | | | |
| Egg + protease, amylase, cellulase, | 595 | 4825 | 126 | 707 | 257 | 3464 | 0 | 6529 |
| oxidase | | | | | | | | |
| Egg + protease, amylase, mannanase, | 613 | 5037 | 176 | 777 | 554 | 3541 | 0 | 15227 |
| oxidase | | | | | | | | |
| Egg + protease, amylase, mannanase, | 676 | 5260 | 143 | 592 | 265 | 3478 | 0 | 13035 |
| cellulase, oxidase | | | | | | | | |
| Egg in Tablet | 5464 | 6025 | 16888 | 37795 | 63292 | 8227 | 7257 | 4788 |

TABLE 8
Assay I: GC Headspace retention measurements for Fish with different enzymes. Channel 1, a cutoff value
of 5,000 was chosen to pick the most relevant peaks, similar trends were seen in channel 2 (data not shown).

| GC HeadSpace Retention Time- | 13.01- | 13.56- | 13.70- | 14.39- | 15.66- | 16.00- | 17.19- | 18.36- |
|---|---|---|---|---|---|---|---|---|
| Channel 1 Run 1 | 1-A | 1-A | 1-A | 1-A | 1-A | 1-A | 1-A | 1-A |
| Fish in Buffer background | 9296 | 0 | 0 | 635592 | 0 | 0 | 0 | 12526 |
| Fish + protease and amylase | 4265 | 0 | 0 | 4506 | 0 | 28304 | 0 | 11699 |
| Fish + protease, amylase, mannanase | 5281 | 0 | 0 | 2491 | 0 | 26373 | 0 | 11487 |
| Fish + protease, amylase, cellulase | 4534 | 0 | 0 | 2788 | 0 | 27315 | 0 | 11161 |
| Fish + protease, amylase, oxidase | 4186 | 0 | 0 | 5074 | 0 | 41757 | 0 | 12514 |
| Fish + protease, amylase, cellulase, | 4714 | 0 | 0 | 2738 | 0 | 25644 | 0 | 11110 |
| mannanase | | | | | | | | |
| Fish + protease, amylase, cellulase, | 4023 | 0 | 0 | 3863 | 0 | 36836 | 0 | 11754 |
| oxidase | | | | | | | | |
| Fish + protease, amylase, mannanase, | 5267 | 0 | 4799 | 42042 | 0 | 0 | 11856 | 0 |
| oxidase | | | | | | | | |
| Fish + protease, amylase, mannanase, | 5116 | 0 | 5332 | 41949 | 0 | 0 | 11238 | 0 |
| cellulase, oxidase | | | | | | | | |
| Fish in Tablet | 3913 | 60723 | 91147 | 9987 | 0 | 0 | 7037 | 3240 |
| GC HeadSpace Retention Time- | 19.50- | 20.45- | 21.32- | 26.48- | 44.72- | 45.74- | 47.21- | 48.91- |
| Channel 1 Run 1 | 1-A | 1-A | 1-A | 1-A | 1-A | 1-A | 1-A | 1-A |
| Fish in Buffer background | 44119 | 0 | 0 | 66221 | 50565 | 0 | 0 | 2961 |
| Fish + protease and amylase | 0 | 16425 | 0 | 197 | 0 | 2748 | 0 | 2538 |
| Fish + protease, amylase, mannanase | 0 | 17547 | 0 | 131 | 0 | 57364 | 0 | 18345 |
| Fish + protease, amylase, cellulase | 0 | 16274 | 0 | 97 | 0 | 10419 | 0 | 4346 |
| Fish + protease, amylase, oxidase | 0 | 17190 | 0 | 192 | 0 | 6194 | 0 | 3387 |
| Fish + protease, amylase, cellulase, | 0 | 16604 | 0 | 71 | 0 | 45311 | 0 | 11305 |
| mannanase | | | | | | | | |
| Fish + protease, amylase, cellulase, | 0 | 16498 | 0 | 148 | 0 | 7960 | 0 | 3198 |
| oxidase | | | | | | | | |
| Fish + protease, amylase, mannanase, | 0 | 0 | 17456 | 0 | 0 | 0 | 44917 | 0 |
| oxidase | | | | | | | | |
| Fish + protease, amylase, mannanase, | 0 | 0 | 16729 | 0 | 0 | 0 | 83758 | 0 |
| cellulase, oxidase | | | | | | | | |
| Fish in Tablet | 0 | 0 | 7851 | 796 | 574 | 349 | 1356 | 0 |
| GC HeadSpace Retention Time- | 51.53- | 58.07- | 59.78- | 62.11- | 87.04- | 90.62- | 92.23- | 96.20- |
| Channel 1 Run 1 | 1-A | 1-A | 1-A | 1-A | 1-A | 1-A | 1-A | 1-A |
| Fish in Buffer background | 609 | 2082 | 0 | 7223 | 579 | 169 | 9509 | 5374 |
| Fish + protease and amylase | 266 | 4042 | 0 | 7557 | 617 | 181 | 8238 | 5861 |
| Fish + protease, amylase, mannanase | 0 | 5715 | 0 | 9348 | 737 | 0 | 9509 | 7489 |
| Fish + protease, amylase, cellulase | 638 | 4243 | 16 | 7701 | 612 | 139 | 8296 | 5898 |
| Fish + protease, amylase, oxidase | 467 | 4996 | 0 | 7628 | 621 | 172 | 9503 | 5466 |
| Fish + protease, amylase, cellulase, | 531 | 4708 | 0 | 8292 | 592 | 34 | 9040 | 5745 |
| mannanase | | | | | | | | |
| Fish + protease, amylase, cellulase, | 346 | 5152 | 0 | 7991 | 656 | 134 | 8317 | 5757 |
| oxidase | | | | | | | | |
| Fish + protease, amylase, mannanase, | 10484 | 5123 | 9086 | 0 | 1579 | 2260 | 853 | 12577 |
| oxidase | | | | | | | | |
| Fish + protease, amylase, mannanase, | 20010 | 6025 | 9714 | 0 | 1628 | 1245 | 655 | 11711 |
| cellulase, oxidase | | | | | | | | |
| Fish in Tablet | 1497 | 6253 | 8079 | 0 | 10189 | 7449 | 1011 | 13312 |
| GC HeadSpace Retention Time- | 99.24- | 104.97- | 107.91- | 109.57- | 110.92- | 112.32- | 114.46- | 115.97- |
| Channel 1 Run 1 | 1-A | 1-A | 1-A | 1-A | 1-A | 1-A | 1-A | 1-A |
| Fish in Buffer background | 6238 | 579 | 1178 | 2081 | 1474 | 0 | 1690 | 0 |
| Fish + protease and amylase | 6528 | 435 | 1321 | 5110 | 993 | 0 | 1569 | 0 |
| Fish + protease, amylase, mannanase | 7290 | 471 | 1207 | 6155 | 1070 | 0 | 1785 | 0 |
| Fish + protease, amylase, cellulase | 6568 | 381 | 1080 | 5815 | 1051 | 0 | 1540 | 0 |
| Fish + protease, amylase, oxidase | 6541 | 369 | 1360 | 6281 | 981 | 0 | 1766 | 0 |
| Fish + protease, amylase, cellulase, | 6497 | 371 | 1220 | 6447 | 1087 | 0 | 1868 | 0 |
| mannanase | | | | | | | | |
| Fish + protease, amylase, cellulase, | 6469 | 432 | 1293 | 6226 | 1007 | 0 | 1604 | 0 |
| oxidase | | | | | | | | |
| Fish + protease, amylase, mannanase, | 1772 | 5866 | 6918 | 861 | 0 | 9709 | 0 | 1998 |
| oxidase | | | | | | | | |
| Fish + protease, amylase, mannanase, | 1780 | 5536 | 6796 | 1429 | 22 | 8771 | 0 | 2034 |
| cellulase, oxidase | | | | | | | | |
| Fish in Tablet | 1758 | 34972 | 73209 | 139866 | 12731 | 19184 | 10799 | 9779 |
| GC HeadSpace Retention Time- | 118.04- | 124.88- | 128.85- | 141.96- | 147.41- | 149.51- | 155.13- | 162.18- |
| Channel 1 Run 1 | 1-A | 1-A | 1-A | 1-A | 1-A | 1-A | 1-A | 1-A |
| Fish in Buffer background | 226 | 63 | 1458 | 697 | 15 | 2811 | 8116 | 385 |
| Fish + protease and amylase | 429 | 27 | 2923 | 989 | 0 | 2835 | 8326 | 377 |
| Fish + protease, amylase, mannanase | 717 | 27 | 39550 | 905 | 0 | 2764 | 8562 | 343 |
| Fish + protease, amylase, cellulase | 752 | 0 | 8142 | 947 | 0 | 2635 | 8431 | 354 |
| Fish + protease, amylase, oxidase | 927 | 0 | 5442 | 891 | 0 | 2899 | 8694 | 381 |
| Fish + protease, amylase, cellulase, | 1144 | 13 | 42090 | 909 | 0 | 2885 | 8220 | 338 |
| mannanase | | | | | | | | |
| Fish + protease, amylase, cellulase, | 1139 | 0 | 7698 | 911 | 0 | 2749 | 8249 | 337 |
| oxidase | | | | | | | | |
| Fish + protease, amylase, mannanase, | 2384 | 32415 | 808 | 1459 | 10897 | 0 | 3133 | 8289 |
| oxidase | | | | | | | | |
| Fish + protease, amylase, mannanase, | 2446 | 38881 | 522 | 1316 | 6232 | 89 | 2898 | 7736 |
| cellulase, oxidase | | | | | | | | |
| Fish in Tablet | 12569 | 11195 | 1591 | 5279 | 8162 | 8600 | 3309 | 11077 |

| GC HeadSpace Retention Time- | 191.32- | 204.95- |
|---|---|---|
| Channel 1 Run 1 | 1-A | 1-A |
| Fish in Buffer background | 6544 | 62 |
| Fish + protease and amylase | 6502 | 83 |
| Fish + protease, amylase, mannanase | 6819 | 67 |
| Fish + protease, amylase, cellulose | 7008 | 84 |
| Fish + protease, amylase, oxidase | 6784 | 63 |
| Fish + protease, amylase, cellulase, | 6876 | 81 |
| mannanase | | |
| Fish + protease, amylase, cellulase, | 7756 | 84 |
| oxidase | | |
| Fish + protease, amylase, mannanase, | 561 | 6248 |
| oxidase | | |
| Fish + protease, amylase, mannanase, | 523 | 7001 |
| cellulase, oxidase | | |
| Fish in Tablet | 603 | 6663 |

TABLE 9
Smell Panel Evaluation

| PANELLIST | 1 | 2 | 3 | 4 | 5 |
|---|---|---|---|---|---|
| | BROCCOLI | | | | |
| Food in Buffer control | 5.0 | 4.0 | 3.0 | 3.0 | 5.0 |
| Food + protease and amylase | 3.0 | 4.0 | 4.0 | 3.0 | 3.0 |
| Food + protease, amylase, mannanase | 2.0 | 4.0 | 5.0 | 1.0 | 2.0 |
| Food + protease, amylase, cellulase | 3.0 | 4.0 | 5.0 | 2.0 | 1.0 |
| Food + protease, amylase, oxidase | 2.0 | 3.0 | 2.0 | 1.0 | 1.0 |
| Food + protease, amylase, cellulase, | 2.0 | 3.0 | 1.0 | 2.0 | 5.0 |
| mannanase | | | | | |
| Food + protease, amylase, cellulase, | 1.5 | 2.0 | 1.0 | 2.0 | 1.0 |
| oxidase | | | | | |
| Food + protease, amylase, mannanase, | 2.0 | 1.0 | 2.0 | 1.0 | 2.0 |
| oxidase | | | | | |
| Food + protease, amylase, mannanase, | 1.5 | 1.0 | 1.0 | 1.0 | 1.0 |
| cellulase, oxidase | | | | | |
| | FISH | | | | |
| Food in Buffer control | 5.0 | 4.0 | 4.0 | 5.0 | 5.0 |
| Food + protease and amylase | 4.0 | 3.0 | 2.0 | 5.0 | 4.0 |
| Food + protease, amylase, mannanase | 3.5 | 3.0 | 1.0 | 5.0 | 4.0 |
| Food + protease, amylase, cellulase | 3.0 | 4.0 | 1.0 | 4.0 | 2.0 |
| Food + protease, amylase, oxidase | 2.5 | 3.0 | 1.0 | 3.0 | 2.0 |
| Food + protease, amylase, cellulase, | 3.0 | 4.0 | 1.0 | 1.0 | 1.0 |
| mannanase | | | | | |
| Food + protease, amylase, cellulase, | 2.0 | 1.0 | 1.0 | 1.0 | 1.0 |
| oxidase | | | | | |
| Food + protease, amylase, mannanase, | 1.5 | 1.0 | 1.0 | 1.0 | 1.0 |
| oxidase | | | | | |
| Food + protease, amylase, mannanase, | 3.0 | 2.0 | 1.0 | 1.0 | 1.0 |
| cellulase, oxidase | | | | | |
| | EGG | | | | |
| Food in Buffer control | 3.0 | 4.0 | 3.0 | 5.0 | 4.0 |
| Food + protease and amylase | 5.0 | 3.0 | 5.0 | 5.0 | 4.0 |
| Food + protease, amylase, mannanase | 2.0 | 3.0 | 2.0 | 5.0 | 3.0 |
| Food + protease, amylase, cellulase | 2.5 | 4.0 | 3.0 | 5.0 | 3.0 |
| Food + protease, amylase, oxidase | 1.0 | 4.0 | 2.0 | 5.0 | 2.0 |
| Food + protease, amylase, cellulase, | 3.5 | 3.0 | 1.0 | 4.0 | 4.0 |
| mannanase | | | | | |
| Food + protease, amylase, cellulase, | 2.0 | 1.0 | 1.0 | 1.0 | 4.0 |
| oxidase | | | | | |
| Food + protease, amylase, mannanase, | 2.0 | 2.0 | 2.0 | 1.0 | 4.0 |
| oxidase | | | | | |
| Food + protease, amylase, mannanase, | 1.0 | 2.0 | 1.0 | 1.0 | 4.0 |
| cellulase, oxidase | | | | | |

### Example 4. Full Scale Washing

The five foodstuffs (Broccoli, Egg, Fish, Onion, and Garlic) were prepared as described under examples under Preparation of foodstuffs for odor generation.

Processing of Foodstuff after Initial Preparation.

Assay Buffer: Buffer pH 8.00. 50 mM HEPES, 50 mM CHES, 1 mM CaCl₂), 0.01% triton X-100.

Water hardness at 21° dH was added to the buffer. The Ca:NaHCO₃:Mg ratio was 4:2:1, prepared using 4000° dH CaCl₂), 2000° dH MgCl2 stock solutions and freshly prepared 0.535 M NaHCO₃.

After this initial preparation, 4×200 mL bottles of buffer were aliquoted. 12.5 g of broccoli, 12.5 g of Fish, 12.5 g of egg, 2 g of onion, and 1 g of garlic was added to each of the four bottles. These were stirred at 500 rpm on a magnetic stirrer for 20 min to allow for homogeneity. These bottles of mixed foods were labelled A, B, C, D.

To bottles A and C, the enzymes according to the experimental set up is shown tables 1-2 above was added to the same end concentration. The enzyme were stirred in the food mix for 5 min. Bottles A, B, C, and D were added to the filter of four Miele GLS2 dishwashing machines. Machines with A and B were then run through a wash program (only with water) immediately at 40° C., using the standard program. R 40° C., 8′/20′/55′ KL 55° C. Machines with C And D were closed and not washed. All four machines were then left for 72 h. After this period all four were run through the wash program with water again, and a panel evaluated the odour of each immediately after the drying phase completion.

The odor panel consists of 5 trained panelists. Each machine was opened, and all 5 panelists performed olfactory evaluation simultaneously. This was repeated for all four machines. The panelists were then asked to compare A vs B and then C vs D, stating which machine had “won” as a ranking based on odour reduction.

TABLE 10
Full Scale Wash Evaluation of Odor in Dishwasher Machines, Those
washed immediately and then left for 72 h, and then washed again.

| Panellists | A | B |
|---|---|---|
| 1 | Win | Lose |
| 2 | Win | Lose |
| 3 | Win | Lose |
| 4 | Win | Lose |
| 5 | Win | Lose |

TABLE 11
Full Scale Wash Evaluation of Odor in Dishwasher
Machines, Those left for 72 h, and then washed.

| Panellists | C | D |
|---|---|---|
| 1 | Win | lose |
| 2 | Lose | Win |
| 3 | Win | Lose |
| 4 | Lose | Win |
| 5 | Win | Lose |

### Example 5. MDW Odor Removal

Determination of the Necessary Enzymes for Odor Removal.

Fresh onions were purchased from a local supermarket (Netto, Bagsværd) and were used untreated and raw after peeling.

Processing of Substrates after Initial Preparation.

Assay Buffer: Buffer pH 8.00. 50 mM HEPES, 50 mM CHES, 1 mM CaCl₂), 0.01% triton X-100.

Water hardness at 21° dH was added to the buffer. The Ca:NaHCO₃:Mg ratio was 4:2:1, prepared using 4000° dH CaCl₂), 2000° dH MgCl2 stock solutions and freshly prepared 0.535 M NaHCO₃.

Onion Preparation:
1 g of blended substrate was added to 100 mL of assay buffer and mixed to a fine liquid suspension (ca. 3 min of blending).
2 replicates of 2 mL were pipetted to the gas E-nose vials.
The substrate was prepared first and after pipetting the lids screwed tightly in place.
The vials were mixed using a whirl mixer for 30 s.
Controls are listed below.
All vials were incubated at 37° C. over 24 h.
E-Nose analysis (Assay I) was carried out and SAS JMP used to perform a principle component analysis of the data to determine which enzymes play a critical role.

TABLE 12
Design, an X indicates the addition n of the enzyme
to the vial as per table 2 concentration.

| | SEQ ID | SEQ ID | SEQ ID | SEQ ID | SEQ ID |
|---|---|---|---|---|---|
| Ref# | NO: 7 | NO: 5 | NO: 1 | NO: 2 | NO: 4 |
| 1/31 | X | | | | |
| 2/32 | | X | | | |
| 3/33 | | | X | | |
| 4/34 | | | | x | |
| 5/35 | | | | | X |
| 6/36 | X | X | | | |
| 7/37 | X | | X | | |
| 8/38 | X | | | x | |
| 9/39 | X | | | | X |
| 10/40 | | x | X | | |
| 11/41 | | x | | x | |
| 12/42 | | x | | | X |
| 13/43 | | | X | x | |
| 14/44 | | | X | | X |
| 15/45 | | | | x | X |
| 16/46 | X | x | X | | |
| 17/47 | X | | X | x | |
| 18/48 | X | | | x | X |
| 19/49 | | x | X | x | |
| 20/50 | | x | X | | X |
| 21/51 | | | X | x | X |
| 22/52 | X | x | | x | |
| 23/53 | X | x | | | X |
| 24/54 | | x | | x | X |
| 25/55 | X | x | X | x | |
| 26/56 | | x | X | x | X |
| 27/57 | X | | X | x | X |
| 28/58 | X | x | | x | X |
| 29/59 | X | x | X | | X |
| 30/60 | X | x | X | x | X |

TABLE 13
E-nose retention measurements (Assay I) for food items with and without enzymes. Channel 1, a cutoff
value of 5,000 was chosen to pick the most relevant peaks, similar trends were seen in channel 2
(data not shown). Where P = protease (SEQ ID NO: 7), A = amylase (SEQ ID NO: 5), C = cellulase
(SEQ ID NO: 1), M = mannanase (SEQ ID NO: 2), O = cellobiose oxidase (SEQ ID NO: 4).

| | 13.07-1- | 13.80-1- | 14.52-1- | 15.86-1- | 18.49-1- | 19.78-1- | 20.75-1- | 21.20-1- |
|---|---|---|---|---|---|---|---|---|
| | A | A | A | A | A | A | A | A |
| Onion + P | 1693.02 | 1193.785 | 181327.5 | 0 | 6499.56 | 106070.3 | 0 | 0 |
| Onion + A | 2483.225 | 3120.72 | 210744.8 | 80495.75 | 0 | 2018109 | 1178889 | 662581.3 |
| Onion + C | 2315.185 | 3150.62 | 230510.4 | 0 | 7508.335 | 66388.54 | 0 | 0 |
| Onion + M | 4465.355 | 5859.28 | 174097.2 | 0 | 6775.39 | 65224.56 | 0 | 0 |
| Onion + O | 3948.38 | 2365.075 | 207007.1 | 32371.53 | 8053.19 | 51931.13 | 0 | 0 |
| Onion + PA | 349.035 | 0 | 157786.8 | 63239.89 | 35.69 | 778642.9 | 823956.6 | 635776.7 |
| Onion + PC | 1542.78 | 0 | 158048.5 | 0 | 6393.405 | 135662.2 | 0 | 0 |
| Onion + PM | 3724.125 | 2460.485 | 242563.5 | 0 | 7737.605 | 64012.97 | 0 | 0 |
| Onion + PO | 2927.975 | 0 | 4022.17 | 103002.6 | 8906.34 | 28101.33 | 0 | 0 |
| Onion + AC | 870.985 | 172.855 | 154132.9 | 3270.245 | 0 | 1352188 | 703896.7 | 168898.5 |
| Onion + AM | 3819.485 | 4364.075 | 397188.6 | 0 | 8886.73 | 295456.1 | 0 | 0 |
| Onion + AO | 5315.445 | 2738.63 | 804135.2 | 0 | 12534.94 | 110744.7 | 0 | 0 |
| Onion + CM | 2316.125 | 2367.36 | 53721.73 | 21580.93 | 6798.895 | 54605.38 | 0 | 0 |
| Onion + CO | 4618.54 | 4965.92 | 325989 | 0 | 8858.455 | 57258.25 | 0 | 0 |
| Onion + MO | 2593.645 | 1208.055 | 47142.54 | 30189.94 | 6981.475 | 46294.3 | 0 | 0 |
| Onion + PAC | 1074.25 | 1319.825 | 180493.4 | 60880.81 | 839.535 | 1523485 | 2044270 | 0 |
| Onion + PCM | 2273.875 | 2775.54 | 130204.8 | 8038.085 | 6408.705 | 60792.13 | 0 | 0 |
| Onion + PMO | 2665.625 | 0 | 3630.715 | 185626.6 | 0 | 0 | 0 | 0 |
| Onion + ACM | 2119.25 | 8060.89 | 452157.8 | 0 | 9219.665 | 239434.4 | 0 | 0 |
| Onion + ACO | 2657.61 | 91.855 | 382264.7 | 3807.255 | 5657.73 | 271087.9 | 84021.03 | 178077.2 |
| Onion + CMO | 2052.11 | 4831.3 | 193067.1 | 40816.52 | 8659.375 | 57585.38 | 0 | 0 |
| Onion + PAM | 3831.155 | 4976.68 | 407922.3 | 0 | 8710.7 | 395173 | 0 | 0 |
| Onion + PAO | 2883.325 | 0 | 4096.515 | 179563.2 | 0 | 0 | 0 | 0 |
| Onion + AMO | 3574.2 | 0 | 6023.205 | 128740.8 | 4125.775 | 17038.27 | 0 | 0 |
| Onion + PACM | 3995.13 | 5006.945 | 438052.3 | 0 | 8743.66 | 435610.8 | 0 | 0 |
| Onion + ACMO | 4571.91 | 0 | 16464.78 | 95371.73 | 13783.19 | 18421.19 | 0 | 0 |
| Onion + PCMO | 2316.075 | 0 | 3227.795 | 162944 | 0 | 0 | 0 | 0 |
| Onion + PAMO | 2640.74 | 0 | 3329.67 | 156026.2 | 9407.52 | 0 | 0 | 0 |
| Onion + PACO | 2493.555 | 0 | 3315.165 | 166471.1 | 0 | 0 | 0 | 0 |
| Onion + | 2250.215 | 0 | 2869.585 | 135063.8 | 16208.05 | 0 | 0 | 0 |
| PACMO | | | | | | | | |
| | 22.12-1- | 22.68-1- | 24.50-1- | 26.61-1- | 30.40-1- | 31.12-1- | 31.77-1- | 36.57-1- |
| | A | A | A | A | A | A | A | A |
| Onion + P | 0 | 2426.355 | 113624.9 | 0 | 0 | 132.435 | 1080.475 | 7066.74 |
| Onion + A | 0 | 0 | 216312 | 0 | 1774.785 | 0 | 19254.47 | 12528.74 |
| Onion + C | 0 | 4501.415 | 116601.5 | 0 | 0 | 0 | 1057.585 | 6373.695 |
| Onion + M | 0 | 6150.535 | 159333.6 | 0 | 0 | 0 | 858.7 | 5750.87 |
| Onion + O | 0 | 0 | 45718.45 | 12541.3 | 240.335 | 0 | 293.375 | 7818.715 |
| Onion + PA | 0 | 0 | 131305.2 | 0 | 7681.48 | 0 | 982.085 | 5511.465 |
| Onion + PC | 0 | 0 | 106519.6 | 0 | 0 | 0 | 1913.52 | 6595.775 |
| Onion + PM | 0 | 7203.135 | 166396.8 | 0 | 0 | 0 | 3179.39 | 6564.6 |
| Onion + PO | 0 | 0 | 14555.21 | 0 | 335.925 | 0 | 394.945 | 5312.25 |
| Onion + AC | 0 | 0 | 122263.7 | 0 | 0 | 0 | 1907.135 | 4484.05 |
| Onion + AM | 0 | 0 | 194972.2 | 0 | 0 | 0 | 11027.67 | 8133.615 |
| Onion + AO | 0 | 0 | 79399.2 | 0 | 654.82 | 0 | 12767.88 | 7872.27 |
| Onion + CM | 0 | 5381.76 | 142288 | 0 | 352.105 | 0 | 2694.5 | 5871.85 |
| Onion + CO | 0 | 1726.79 | 56373.3 | 10865.8 | 834.765 | 0 | 541.645 | 6969.6 |
| Onion + MO | 5179.31 | 0 | 86884.65 | 0 | 0 | 0 | 1395.765 | 5802.545 |
| Onion + PAC | 0 | 0 | 198688.5 | 0 | 0 | 0 | 16370.36 | 9354.28 |
| Onion + PCM | 0 | 6416.12 | 166730.2 | 0 | 515.51 | 0 | 1971.4 | 5263.63 |
| Onion + PMO | 1003.565 | 656.39 | 6990.07 | 0 | 596.415 | 0 | 594.54 | 6361.13 |
| Onion + ACM | 0 | 4902.485 | 201632.1 | 0 | 0 | 0 | 9960.2 | 8323.95 |
| Onion + ACO | 0 | 0 | 54839.82 | 0 | 660.13 | 0 | 11175.01 | 6815.635 |
| Onion + CMO | 0 | 1621.71 | 94525.36 | 0 | 0 | 0 | 2180.31 | 5368.785 |
| Onion + PAM | 0 | 4212.355 | 198890.5 | 0 | 0 | 0 | 10347.87 | 6872.2 |
| Onion + PAO | 0 | 1512.335 | 5254.165 | 0 | 773.325 | 0 | 1234.345 | 5189.76 |
| Onion + AMO | 0 | 661.495 | 31290.68 | 0 | 929.74 | 0 | 1204.225 | 5361.625 |
| Onion + PACM | 0 | 5327.47 | 211331.6 | 0 | 0 | 0 | 12797.71 | 6871.59 |
| Onion + ACMO | 0 | 2663.57 | 39258.62 | 0 | 253.485 | 0 | 825.25 | 5063.71 |
| Onion + PCMO | 202.345 | 817.015 | 6254.42 | 0 | 653.04 | 0 | 389.37 | 5342.37 |
| Onion + PAMO | 0 | 1511.025 | 5527.71 | 0 | 725.395 | 0 | 495.87 | 6155.415 |
| Onion + PACO | 371.805 | 1415.84 | 5841.365 | 0 | 1170.295 | 0 | 993.62 | 5381.35 |
| Onion + | 0 | 762.83 | 4277.475 | 0 | 700.005 | 0 | 430.555 | 5493.65 |
| PACMO | | | | | | | | |
| | 39.86-1- | 45.99-1- | 47.42-1- | 50.43-1- | 60.42-1- | 62.30-1- | 65.22-1- | 83.83-1- |
| | A | A | A | A | A | A | A | A |
| Onion + P | 791.44 | 1971.66 | 12461.52 | 0 | 0 | 14409.05 | 4932.85 | 37604.29 |
| Onion + A | 4254.635 | 7862.125 | 11425.15 | 0 | 4134.66 | 17076.94 | 4827.97 | 33470.48 |
| Onion + C | 579.955 | 3142.855 | 12526.67 | 0 | 0 | 14532.09 | 5130 | 37199.48 |
| Onion + M | 301.52 | 2253.135 | 3931.64 | 0 | 0 | 14500.55 | 5319 | 18560.28 |
| Onion + O | 189.005 | 15974.93 | 5655.435 | 3694.96 | 0 | 14914.19 | 7885.055 | 18462.4 |
| Onion + PA | 407.095 | 5864.46 | 13115.24 | 0 | 2896.865 | 16666.41 | 4400.805 | 33203.46 |
| Onion + PC | 450.035 | 2490.64 | 14312.61 | 0 | 0 | 15746.29 | 4649.505 | 37919.34 |
| Onion + PM | 868.78 | 1743.625 | 1757.73 | 155.245 | 0 | 15374.86 | 4338.465 | 12640.75 |
| Onion + PO | 47.65 | 865.67 | 0 | 1466.865 | 0 | 16353.05 | 15705.96 | 3055.185 |
| Onion + AC | 686.21 | 5756.285 | 11270.95 | 0 | 3360.845 | 17181.48 | 4233.89 | 34483.77 |
| Onion + AM | 1336.845 | 4312.795 | 3149.005 | 0 | 0 | 16924.15 | 4711.195 | 13159.3 |
| Onion + AO | 1128.445 | 12013.47 | 3374.255 | 0 | 0 | 15846.81 | 4014.145 | 14955.92 |
| Onion + CM | 344.505 | 2731.66 | 2709.225 | 12857.02 | 0 | 15855.5 | 3441.355 | 13629.57 |
| Onion + CO | 252.63 | 16628.3 | 7944.205 | 0 | 0 | 15305.37 | 3998.115 | 24583.82 |
| Onion + MO | 404.575 | 1356.07 | 380.035 | 2891.2 | 0 | 16180.55 | 4608.655 | 5809.57 |
| Onion + PAC | 1362.035 | 6647.695 | 9668.645 | 0 | 3057.505 | 17841.94 | 3860.065 | 31760.76 |
| Onion + PCM | 328.28 | 2354.36 | 2704.65 | 0 | 0 | 15337.36 | 4125.76 | 14868.14 |
| Onion + PMO | 220.17 | 1697.535 | 0 | 0 | 0 | 16063.16 | 15129.99 | 2271.765 |
| Onion + ACM | 1946.56 | 5809.655 | 3451.585 | 0 | 0 | 15711.53 | 4117.495 | 14112.96 |
| Onion + ACO | 2156.645 | 16052.89 | 5475.545 | 0 | 714.915 | 16314.44 | 3686.255 | 17859.47 |
| Onion + CMO | 519.205 | 7024.215 | 1274.395 | 2958.735 | 0 | 15513.42 | 4599.02 | 7821.2 |
| Onion + PAM | 924.495 | 4010.56 | 2975.07 | 0 | 0 | 15476.17 | 3876.755 | 13543.89 |
| Onion + PAO | 125.8 | 3153.325 | 0 | 0 | 0 | 15508.17 | 14357.31 | 1861.34 |
| Onion + AMO | 0 | 4687.68 | 0 | 18573.64 | 0 | 16198.68 | 7521.145 | 2509 |
| Onion + PACM | 1178.375 | 7910.8 | 3860.415 | 0 | 0 | 16091.45 | 3735.945 | 14666.91 |
| Onion + ACMO | 218.745 | 8066.205 | 0 | 9098.36 | 0 | 15202.36 | 7858.95 | 2495.935 |
| Onion + PCMO | 0 | 3626.405 | 0 | 0 | 0 | 15192.24 | 13615.49 | 1975.02 |
| Onion + PAMO | 135.815 | 4319.845 | 0 | 0 | 0 | 16372.64 | 14199.29 | 1812.8 |
| Onion + PACO | 205.34 | 2949.905 | 0 | 0 | 0 | 15904.59 | 14038.02 | 1786.025 |
| Onion + | 0 | 4234.15 | 0 | 0 | 0 | 16068.85 | 13267.05 | 1717.265 |
| PACMO | | | | | | | | |
| | 109.41- | 112.13- | 114.86- | 130.36- | 139.63- | 159.67- | 193.05- | 109.41- |
| | 1-A | 1-A | 1-A | 1-A | 1-A | 1-A | 1-A | 1-A |
| Onion + P | 72104.44 | 15419.15 | 9126.405 | 3903.805 | 22092.73 | 7774.455 | 4051.55 | 72104.44 |
| Onion + A | 66300.83 | 13754.07 | 12516.15 | 6243.98 | 25107.29 | 7920.03 | 4495.255 | 66300.83 |
| Onion + C | 65411.54 | 13785.93 | 9279.195 | 3635.735 | 26340.99 | 8022.48 | 4376.08 | 65411.54 |
| Onion + M | 52806.61 | 7689.305 | 7938.865 | 4595.055 | 20160.5 | 7857.31 | 3889.59 | 52806.61 |
| Onion + O | 49932.22 | 9058.72 | 6691.675 | 1905.96 | 16616.68 | 6689.16 | 3241.005 | 49932.22 |
| Onion + PA | 48120.5 | 12096.23 | 11334.61 | 3942.08 | 21470.44 | 8822.595 | 3848.88 | 48120.5 |
| Onion + PC | 48721.09 | 12914.68 | 9046.92 | 3958.5 | 22404.13 | 7786.355 | 4099.32 | 48721.09 |
| Onion + PM | 38128.52 | 4335.63 | 6939.555 | 3297.08 | 15029.6 | 7833.605 | 2697.615 | 38128.52 |
| Onion + PO | 18268.86 | 7035.55 | 3524.265 | 2042.435 | 9809.04 | 7270.185 | 3712.215 | 18268.86 |
| Onion + AC | 52441.94 | 12089.38 | 12254.52 | 5976.2 | 25308.87 | 8711.55 | 3919.815 | 52441.94 |
| Onion + AM | 36707.5 | 4234.54 | 8645.395 | 12784.92 | 15656.68 | 8050.815 | 3019.155 | 36707.5 |
| Onion + AO | 44819.35 | 5240.23 | 8214.58 | 9031.915 | 15543.65 | 7507.76 | 4025.16 | 44819.35 |
| Onion + CM | 40212.86 | 6365.05 | 5919.275 | 3412.14 | 25734.76 | 7444.555 | 4036.26 | 40212.86 |
| Onion + CO | 48386.32 | 7410.85 | 8822.905 | 2431.295 | 16839.58 | 7793.2 | 4540.265 | 48386.32 |
| Onion + MO | 31985.89 | 8717.44 | 5911.96 | 2840.48 | 15573.19 | 7844.89 | 4440.74 | 31985.89 |
| Onion + PAC | 44492.68 | 9995.685 | 11372.47 | 8544.435 | 21799.75 | 8484.41 | 4131.44 | 44492.68 |
| Onion + PCM | 39161.15 | 4764.455 | 7189.495 | 4870.94 | 14805.26 | 8202.535 | 3798.82 | 39161.15 |
| Onion + PMO | 14918.1 | 5964.915 | 3239.705 | 4651.11 | 13363.97 | 7378.16 | 3650.605 | 14918.1 |
| Onion + ACM | 35693.57 | 3293.5 | 7612.73 | 6104.505 | 14790.53 | 8478.1 | 3166.73 | 35693.57 |
| Onion + ACO | 40577.55 | 6358.445 | 10167.19 | 4802.155 | 15886.1 | 7860.245 | 3914.765 | 40577.55 |
| Onion + CMO | 29944.3 | 7475.86 | 5960.88 | 2661.22 | 15345.11 | 7595.06 | 3912.565 | 29944.3 |
| Onion + PAM | 33568.13 | 2674.18 | 8107.99 | 3894.155 | 14635.48 | 7867.58 | 3907.615 | 33568.13 |
| Onion + PAO | 12225.37 | 4857.56 | 2980.125 | 8977.835 | 10594.3 | 7274.35 | 3384.945 | 12225.37 |
| Onion + AMO | 19344.58 | 7074.21 | 3808.56 | 21563.79 | 18519.15 | 8471.01 | 4306.885 | 19344.58 |
| Onion + PACM | 33790.27 | 2529.135 | 8672.405 | 9482.605 | 14444.75 | 7463.55 | 3095.175 | 33790.27 |
| Onion + ACMO | 17532.72 | 5610.975 | 4553.295 | 11722.8 | 12846.7 | 7519.5 | 3403.62 | 17532.72 |
| Onion + PCMO | 12887.23 | 4863.695 | 3312.18 | 3829.265 | 12278.65 | 8501.28 | 3991.87 | 12887.23 |
| Onion + PAMO | 12631.78 | 4443.66 | 3189.335 | 17530.01 | 12705.32 | 7585.415 | 3622.585 | 12631.78 |
| Onion + PACO | 11026.31 | 4360.555 | 2817.38 | 10079.8 | 10759.32 | 7098.595 | 3681.155 | 11026.31 |
| Onion + | 12047.41 | 4070.63 | 3161.265 | 12182.35 | 11277.06 | 8118.06 | 3496.99 | 12047.41 |
| PACMO | | | | | | | | |

1-5. (canceled)

6. A cleaning composition, comprising a builder and at least one enzyme for preventing, reducing or removing odor from a hard surface, wherein the at least one enzyme is an alkaline cellulase or an enzyme having mannanase activity.

7. A composition according to claim 6, wherein the composition is a dish wash composition.

8. A composition according to claim 6, additionally comprising an oxidase.

9. A composition according to claim 6, additionally comprising a surfactant.

10. A composition according to claim 6, additionally comprising a polymer.

11. A method for washing a hard surface, comprising:
(i) exposing the hard surface to a wash liquor comprising an alkaline cellulase or an enzyme having mannanase activity, and
(ii) rinsing the hard surface with water optionally comprising a rinsing aid.

12. The method according to claim 11, wherein the hard surface is in the interior of a dishwashing machine or a sink.

13. The method according to claim 11, wherein the method is hand dishwashing or automatic dish washing.

14. The method according to claim 11, wherein the alkaline cellulase has endo-beta-1,4-glucanase activity (EC 3.2.1.4).

15. The method according to claim 11, wherein the wash liquor additionally comprises an oxidase.

16. The cleaning composition according to claim 6, comprising an alkaline cellulase, an enzyme having mannanase activity and an oxidase.

17. The cleaning composition according to claim 6, wherein the alkaline cellulase comprises an amino acid sequence having at least 90% sequence identity to SEQ ID NO: 1, and the enzyme having mannanase activity comprises an amino sequence having at least 90% sequence identity to SEQ ID NO: 2.

18. The method according to claim 11, wherein the wash liquor comprises an alkaline cellulase, an enzyme having mannanase activity and an oxidase.

19. The method according to claim 11, wherein the alkaline cellulase comprises an amino acid sequence having at least 90% sequence identity to SEQ ID NO: 1, and the enzyme having mannanase activity comprises an amino sequence having at least 90% sequence identity to SEQ ID NO: 2.

20. The method according to claim 11, wherein the hard surface is odorous before the washing, the odor on the hard surface is reduced by the washing method, and the odor on the hard surface after the washing method is reduced as compared to washing the hard surface using a wash liquor that lacks an alkaline cellulase and an enzyme having mannanase activity.


SEQUENCE LISTING (7 sequences)

SEQ ID NO: 1 - protein, 773 aa, Bacillus sp.
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 2 - protein, 299 aa, Bacillus bogoriensis
ANSGFYVSGTTLYDANGNPFVMRGINHGHAWYKDQATTAIEGIANTGANTVRIVLSDGGQWTKDDIHTVRNLISLAEDNHLVAVLEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFQ

SEQ ID NO: 3 - protein, 605 aa, Aspergillus niger
MQTLLVSSLVVSLAAALPHYIRSNGIEASLLTDPKDVSGRTVDYIIAGGGLTGLTTAARLTENPNISVLVIESGSYESDRGPIIEDLNAYGDIFGSSVDHAYETVELATNNQTALIRSGNGLGGSTLVNGGTWTRPHKAQVDSWETVFGNEGWNWDNVAAYSLQAERARAPNAKQIAAGHYFNASCHGVNGTVHAGPRDTGDDYSPIVKALMSAVEDRGVPTKKDFGCGDPHGVSMFPNTLHEDQVRSDAAREWLLPNYQRPNLQVLTGQYVGKVLLSQNGTTPRAVGVEFGTHKGNTHNVYAKHEVLLAAGSAVSPTILEYSGIGMKSILEPLGIDTVVDLPVGLNLQDQTTATVRSRITSAGAGQGQAAWFATFNETFGDYSEKAHELLNTKLEQWAEEAVARGGFHNTTALLIQYENYRDWIVNHNVAYSELFLDTAGVASFDVWDLLPFTRGYVHILDKDPYLHHFAYDPQYFLNELDLLGQAAATQLARNISNSGAMQTYFAGETIPGDNLAYDADLSAWTEYIPYHFRPNYHGVGTCSMMPKEMGGVVDNAARVYGVQGLRVIDGSIPPTQMSSHVMTVFYAMALKISDAILEDYASMQ

SEQ ID NO: 4 - protein, 495 aa, microdochium nivale
MRSAFILALGLITASADALVTRGAIEACLSAAGVPIDIPGTADYERDVEPFNIRLPYIPTAIAQTQTTAHIQSAVQCAKKLNLKVSAKSGGHSYASFGFGGENGHLMVQLDRMIDVISYNDKTGIAHVEPGARLGHLATVLNDKYGRAISHGTCPGVGISGHFAHGGFGFSSHMHGLAVDSVVGVTVVLADGRIVEASATENADLFWGIKGAGSNFGIVAVWKLATFPAPKVLTRFGVTLNWKNKTSALKGIEAVEDYARWVAPREVNFRIGDYGAGNPGIEGLYYGTPEQWRAAFQPLLDTLPAGYVVNPTTSLNWIESVLSYSNFDHVDFITPQPVENFYAKSLTLKSIKGDAVKNFVDYYFDVSNKVKDRFWFYQLDVHGGKNSQVTKVTNAETAYPHRDKLWLIQFYDRYDNNQTYPETSFKFLDGWVNSVTKALPKSDWGMYINYADPRMDRDYATKVYYGENLARLQKLKAKFDPTDRFYYPQAVRPVK

SEQ ID NO: 5 - protein, 483 aa, Bacillus sp. AA560
HHNGTNGTLMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVKAVEVNPNNRNQEVSGEYTIEAWTKFDFPGRANTHSNFKWRWYHFDGVDWDQSRKLNNRIYKFRTKAWDWEVDTEFGNYDYLLYADIDMDHPEVVNELRNWGVWYTNTLGLDGFRIDAVKHIKYSFTRDWINHVRSAIGKNMFAVAEFWKNDLGAIENYLNKTNWNHSVFDVPLHFNLYYASKSGGNYDMRQIFNGTVVQKHPTHAVTFVDNHDSQPEESLESFVREWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNKAGTVTINADGWGNFSVNGGSVSIWVNK

SEQ ID NO: 6 - protein, 270 aa, Bacillus sp.
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGAADGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 7 - protein, 269 aa, Bacillus lentus
AQSVPWGIRRVQAPTAHNRGLTGSGVKVAVLDTGISTHPDLNIRGGASFVPGEPSTQDGNGHGTHAAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLDGTSMATPHVAGAAALVKQKNPSWSNVRIRNHLKNTATSLGSTNLYGSGLVNAEAATR